(19) United States
(12) Patent Application Publication
(10) Pub. No.: US 2020/0363249 A1
(43) Pub. Date: Nov. 19, 2020

(54) PHYSICAL QUANTITY MEASUREMENT DEVICE

(71) Applicant: DENSO CORPORATION, Kariya-city (JP)

(72) Inventor: Kengo ITO, Kariya-city (JP)

(21) Appl. No.: 16/985,359

(22) Filed: Aug. 5, 2020

Related U.S. Application Data
(63) Continuation of application No. PCT/JP2019/003960, filed on Feb. 5, 2019.

(30) Foreign Application Priority Data
Feb. 7, 2018 (JP) 2018-020388
Dec. 26, 2018 (JP) 2018-243415

(51) Int. Cl. G01F 1/69; G01F 5/00

(52) U.S. Cl. CPC G01F 1/69; G01F 5/00

(57) ABSTRACT

A physical quantity measurement device includes a measurement flow path that includes a sensor path in which a physical quantity sensor is disposed, an upstream curved path curved between the sensor path and an inlet, and a downstream curved path curved between the sensor path and an outlet. An inner surface of a housing includes an upstream outer curved surface that defines an outer outline of the upstream curved path, and a downstream outer curved surface that defines an outer outline of the downstream curved path. An arrangement line is an imaginary straight line passing through the physical quantity sensor between the upstream curved path and the downstream curved path. On the arrangement line, a distance between the downstream outer curved surface and the physical quantity sensor is larger than a distance between the upstream outer curved surface and the physical quantity sensor.

### CROSS REFERENCE TO RELATED APPLICATIONS

The present application is a continuation application of International Patent Application No. PCT/JP2019/003960 filed on Feb. 5, 2019, which designated the U.S. and claims the benefit of priority from Japanese Patent Application No. 2018-020388 filed on Feb. 7, 2018, and Japanese Patent Application No. 2018-243415 filed on Dec. 26, 2018.

### TECHNICAL FIELD

The present invention relates to a physical quantity measurement device.

### BACKGROUND

A physical quantity measurement device measures a physical quantity of a fluid.

### SUMMARY

According to at least one embodiment of the present disclosure, a physical quantity measurement device measures a physical quantity of a fluid. The physical quantity measurement device includes: a measurement flow path including a measurement inlet through which the fluid flows into the measurement flow path, and a measurement outlet through which the fluid that has flowed in from the measurement inlet flows out of the measurement flow path; a physical quantity sensor that is provided in the measurement flow path and detects the physical quantity of the fluid; and a housing that defines the measurement flow path. The measurement flow path includes: a sensor path in which the physical quantity sensor is disposed; an upstream curved path provided between the sensor path and the measurement inlet in the measurement flow path, the upstream curved path being curved in the housing so as to extend from the sensor path toward the measurement inlet; and a downstream curved path provided between the sensor path and the measurement outlet in the measurement flow path, the downstream curved path being curved in the housing so as to extend from the sensor path toward the measurement outlet. An inner surface of the housing includes: an upstream outer curved surface that defines an outer outline of a curved part of the upstream curved path; and a downstream outer curved surface that defines an outer outline of a curve part of the downstream curved path. An arrangement line is defined as an imaginary straight line that passes through the physical quantity sensor and extends in an arrangement direction in which the upstream curved path and the downstream curved path are arranged. A distance on the arrangement line between the downstream outer curved surface and the physical quantity sensor is larger than a distance on the arrangement line between the upstream outer curved surface and the physical quantity sensor.

### BRIEF DESCRIPTION OF DRAWINGS

The details of one or more embodiments are set forth in the accompanying drawings and the description below. Other features and advantages will be apparent from the description and drawings, and from the claims.

FIG. 1 is a diagram showing a configuration of a combustion system according to a first embodiment.

FIG. 2 is a front view of an air flow meter attached to an intake pipe.

FIG. 3 is a plan view of the air flow meter attached to the intake pipe.

FIG. 4 is a perspective view of the air flow meter viewed from a through inlet.

FIG. 5 is a perspective view of the air flow meter viewed from a through outlet.

FIG. 6 is a side view of the air flow meter viewed from a connector portion.

FIG. 7 is a side view of the air flow meter viewed from a side opposite the connector portion.

FIG. 8 is a cross-sectional view taken along a line VIII-VIII of FIG. 2.

FIG. 9 is a perspective view of a sensor SA.

FIG. 10 is a plan view of the sensor SA viewed from a molded front surface.

FIG. 11 is a plan view of the sensor SA viewed from a molded back surface.

FIG. 12 is a perspective view of a flow rate sensor.

FIG. 13 is a diagram showing a wiring pattern of a membrane portion.

FIG. 14 is a vertical cross-sectional view of the air flow meter.

FIG. 15 is an enlarged view around a sensor path of FIG. 14.

FIG. 16 is a cross-sectional view taken along a line XVI-XVI in FIG. 14.

FIG. 17 is an enlarged view around a sensor path of FIG. 16.

FIG. 18 is a vertical cross-sectional view around a sensor path in an air flow meter according to a second embodiment.

FIG. 19 is a horizontal cross-sectional view of an air flow meter according to a third embodiment.

### DETAILED DESCRIPTION

A comparative example will be described. A physical quantity measurement device of the comparative example that measures a physical quantity of a fluid is an air flow rate measurement device which includes a housing that forms a sub-bypass flow path, and a flow rate sensor that detects a flow rate of air flowing through the sub-bypass flow path. In this air flow rate measurement device, the sub-bypass flow path includes a sub-inlet through which air flows into the sub-bypass flow path, and a sub-outlet through which the inflow air flows out of the sub-bypass flow path. The sub-bypass flow path has a flow path shape in which an air flow is U-turned between the sub-inlet and the sub-outlet. In the sub-bypass flow path, a flow rate sensor is provided between a portion curved toward the sub inlet and a portion curved toward the sub outlet.

In the comparative example, the air flows into the sub-bypass flow path through the sub-inlet and passes through the flow rate sensor. Then, the air hits a wall surface of the portion curved toward the sub-outlet in the sub-bypass flow path, and thereby turbulence of the air flow may occur in the sub-bypass flow path. For example, the air hitting the wall surface may flow back through the sub-bypass flow path and return to the flow rate sensor. In this case, turbulence of the air flow passing through the flow rate sensor may occur in the sub-bypass flow path, and an accuracy in detection of a flow rate by the flow rate sensor is likely to deteriorate. Therefore, the accuracy in measurement of a physical quantity such as a flow rate of a fluid such as air may decrease, and a measurement accuracy of the physical quantity measurement device may decrease.

In contrast, according to the present disclosure, a physical quantity measurement device is capable of improving an accuracy in measurement of a physical quantity.

According to an aspect of the present disclosure, a physical quantity measurement device measures a physical quantity of a fluid. The physical quantity measurement device includes: a measurement flow path including a measurement inlet through which the fluid flows into the measurement flow path, and a measurement outlet through which the fluid that has flowed in from the measurement inlet flows out of the measurement flow path; a physical quantity sensor that is provided in the measurement flow path and detects the physical quantity of the fluid; and a housing that defines the measurement flow path. The measurement flow path includes: a sensor path in which the physical quantity sensor is disposed; an upstream curved path provided between the sensor path and the measurement inlet in the measurement flow path, the upstream curved path being curved in the housing so as to extend from the sensor path toward the measurement inlet; and a downstream curved path provided between the sensor path and the measurement outlet in the measurement flow path, the downstream curved path being curved in the housing so as to extend from the sensor path toward the measurement outlet. An inner surface of the housing includes: an upstream outer curved surface that defines an outer outline of a curved part of the upstream curved path; and a downstream outer curved surface that defines an outer outline of a curve part of the downstream curved path. An arrangement line is defined as an imaginary straight line that passes through the physical quantity sensor and extends in an arrangement direction in which the upstream curved path and the downstream curved path are arranged. A distance on the arrangement line between the downstream outer curved surface and the physical quantity sensor is larger than a distance on the arrangement line between the upstream outer curved surface and the physical quantity sensor.

According to the above aspect, on the arrangement line, the distance between the physical quantity sensor and the downstream outer curved surface is larger than the distance between the physical quantity sensor and the upstream outer curved surface. In this configuration, the physical quantity sensor can be placed at a position as far as possible from the downstream outer curved surface between the upstream outer curved surface and the downstream outer curved surface. Therefore, even if the fluid that has passed through the physical quantity sensor in the measurement flow path hits the downstream outer curved surface and flows backward in a direction toward the physical quantity sensor, the backward flow is difficult to reach the physical quantity sensor. Further, even if a turbulence of gaseous fluid due to the backward flow occurs around the downstream outer curved surface, this turbulence hardly reach the physical quantity sensor. Therefore, deterioration in detection accuracy of the physical quantity sensor due to the turbulence of the gaseous fluid in the measurement flow path can be reduced. Such increase in the physical-quantity measurement accuracy of the physical quantity sensor leads to enhancement in physical-quantity measurement accuracy of the physical quantity measurement device.

Hereinafter, multiple embodiments of the present disclosure will be described with reference to the drawings. Incidentally, the same reference numerals are assigned to the corresponding components in each embodiment, and thus, duplicate descriptions may be omitted. When only a part of the configuration is described in each embodiment, the configuration of the other embodiments described above can be applied to the other parts of the configuration. Further, not only the combinations of the configurations explicitly shown in the description of the respective embodiments, but also the configurations of the plurality of embodiments can be partially combined together even if the configurations are not explicitly shown if there is no problem in the combination in particular. Unspecified combinations of the configurations described in the plurality of embodiments and the modification examples are also disclosed in the following description.

### First Embodiment

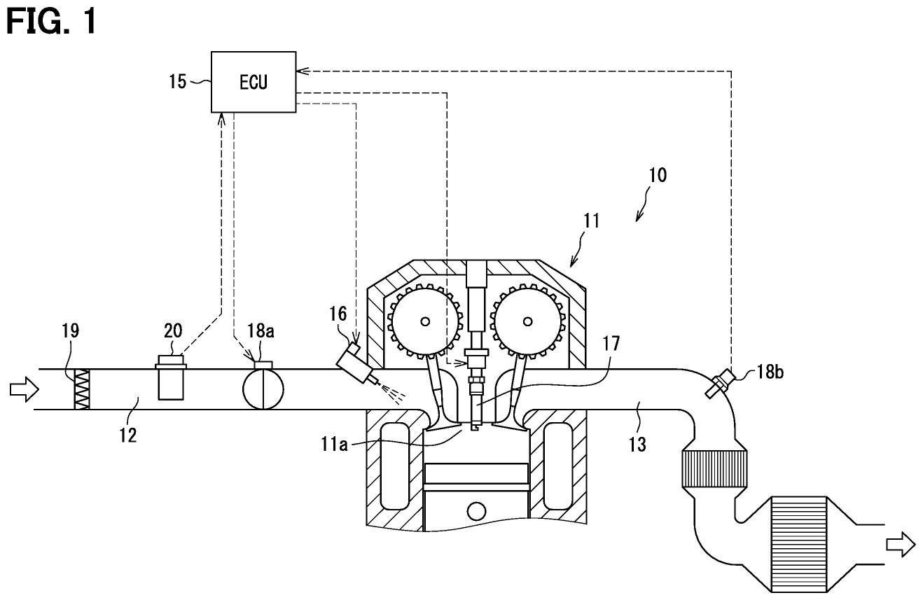

A combustion system 10 shown in FIG. 1 includes an internal combustion engine 11 such as a gasoline engine, an intake passage 12, an exhaust passage 13, an air flow meter 20, and an ECU 15, and the combustion system 10 is mounted on a vehicle, for example. The air flow meter 20 is provided in the intake passage 12 and measures physical quantities such as a flow rate, a temperature, a humidity, and a pressure of an intake air supplied to the internal combustion engine 11. The air flow meter 20 is a flow rate measurement device that measures the flow rate of air, and corresponds to a physical quantity measurement device that measures a fluid such as intake air. The intake air is a gas supplied to a combustion chamber 11a of the internal combustion engine 11. In the combustion chamber 11a, a mixture of the intake air and a fuel is ignited by an ignition plug 17.

The ECU (Engine Control Unit) 15 is a controller for controlling an operation of the combustion system 10. The ECU 15 is a calculation processing circuit including a processor, a storage medium such as a RAM, a ROM and a flash memory, a microcomputer including an input and output unit, a power supply circuit, and the like. The ECU 15 receives a sensor signal output from the air flow meter 20, sensor signals output from a large number of vehicle-mounted sensors, and the like. The ECU 15 uses measurement results of the air flow meter 20 to perform an engine control such as control of a fuel injection amount and an EGR amount of an injector 16. The ECU 15 is a controller that controls an operation of the internal combustion engine 11, and the combustion system 10 may be referred to as an engine control system. The ECU 15 corresponds to an external device.

The ECU 15 may also be referred to as an electronic control unit. The control unit or the control system is provided by (a) an algorithm as a plurality of logic called an if-then-else form, or (b) a learned model tuned by machine learning, e.g., an algorithm as a neural network.

The controller is provided by a control system including at least one computer. The control system may include a plurality of computers linked by data communication devices. The computer includes at least one processor (hardware processor) that is hardware. The hardware processor can be provided by the following (i), (ii), or (iii).

(i) The hardware processor may be at least one processor core that executes a program stored in at least one memory. In this case, the computer is provided by at least one memory and at least one processor core. The processor core is called CPU: Central Processing Unit, GPU: Graphics Processing Unit, or RISC-CPU, for example. The memory is also called a storage medium. The memory is a non-transitory and tangible storage medium, which non-temporarily stores a program and/or data readable by the processor. The storage medium may be a semiconductor memory, a magnetic disk, an optical disk, or the like. The program may be distributed as a single unit or as a storage medium in which the program is stored.

(ii) The hardware processor may be a hardware logic circuit. In this case, the computer is provided by a digital circuit including a number of programmed logic units (gate circuits). The digital circuit is also called, for example, a logic circuit array, an ASIC (Application Specific Integrated Circuit), a FPGA (Field Programmable Gate Array), an SOC (System on a Chip), a PGA (Programmable Gate Array), or a CPLD (Complex Programmable Logic Device), for example. The digital circuit may comprise a memory storing programs and/or data. The computer may be provided by an analog circuit. A computer may be provided by a combination of a digital circuit and an analog circuit.

(iii) The hardware processor may be a combination of the above (i) and the above (ii). (i) and (ii) are placed on different chips or on a common chip. In these cases, the part (ii) is also called an accelerator.

The control device, the signal source, and the control object provide various elements. At least some of these elements may be referred to as blocks, modules, or sections. Furthermore, elements included in the control system are referred to as functional means only when intentional.

A control units and methods described in the present disclosure may be implemented by a special purpose computer which is configured with a memory and a processor programmed to execute one or more particular functions embodied in computer programs of the memory. Alternatively, the control unit and the method described in the present disclosure may be implemented by a dedicated computer configured as a processor with one or more dedicated hardware logic circuits. Alternatively, the control unit and the method described in the present disclosure may be realized by one or more dedicated computer, which is configured as a combination of a processor and a memory, which are programmed to perform one or more functions, and a processor which is configured with one or more hardware logic circuits. The computer programs may be stored, as instructions to be executed by a computer, in a tangible non-transitory computer-readable medium.

The combustion system 10 includes measurement units as in-vehicle sensors. As the measurement units, in addition to the air flow meter 20, there are a throttle sensor 18a and an air-fuel ratio sensor 18b, for example. Each of these measurement units is electrically connected to the ECU 15 and outputs a detection signal to the ECU 15. The air flow meter 20 is in the intake passage 12, and provided downstream of an air cleaner 19 and upstream of a throttle valve provided with the throttle sensor 18a.

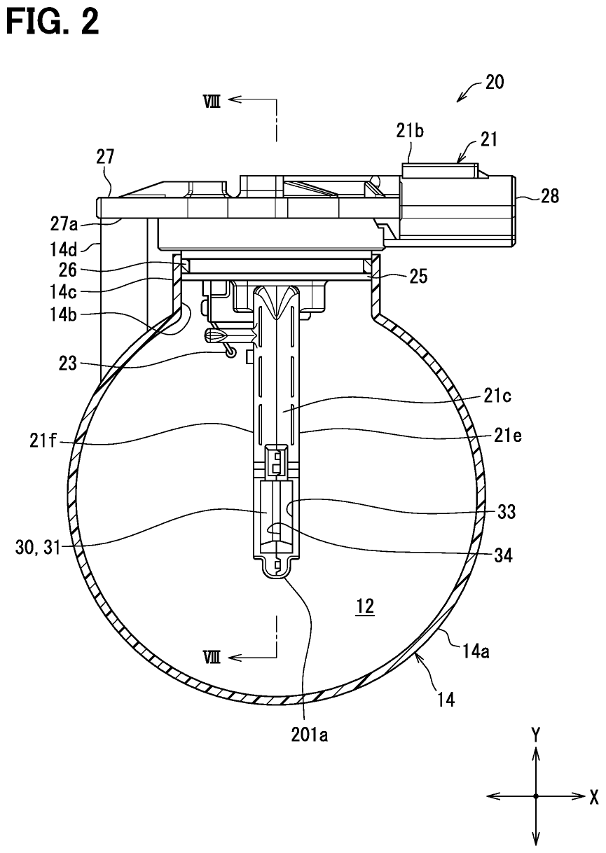

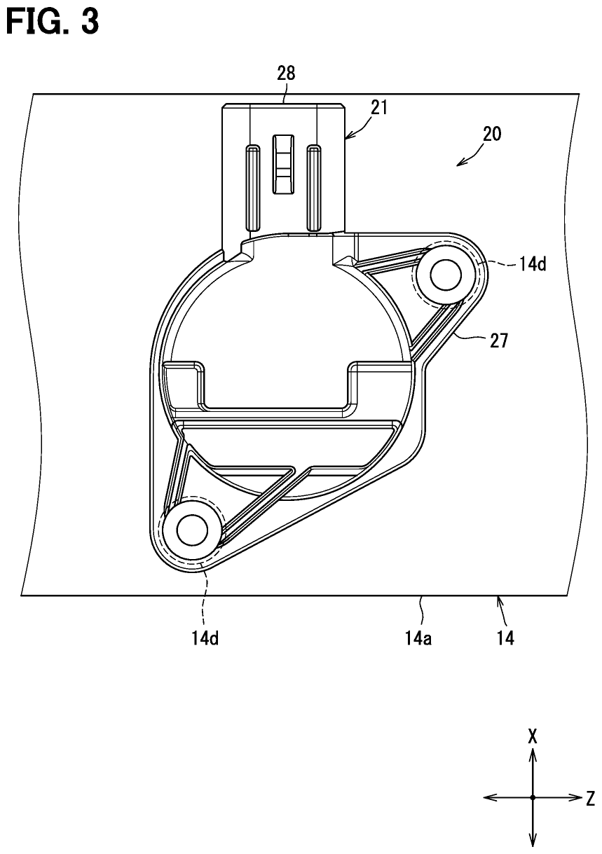

As shown in FIGS. 2, 3 and 8, the air flow meter 20 is attached to a piping unit 14 as an attachment object. The piping unit 14 includes an intake pipe 14a, a pipe flange 14c, and a pipe boss 14d, and is a forming member that forms the intake passage 12. The intake pipe 14a, the pipe flange 14c, and the pipe boss 14d are made of a resin material, for example.

The intake pipe 14a is a pipe such as a duct that forms the intake passage 12. The intake pipe 14a is provided with an airflow insertion hole 14b as a through hole that penetrates through an outer periphery of the intake pipe 12a. The pipe flange 14c is formed in an annular shape and extends along a circumferential edge of the airflow insertion hole 14b. The pipe flange 14c extends from an outer surface of the intake pipe 14a in a direction away from the intake passage 12. The pipe boss 14d is a columnar member, and is a support portion that supports the air flow meter 20. The pipe boss 14d extends from the outer surface of the intake pipe 14a along the pipe flange 14c. Multiple pipe bosses 14d (e.g. two pipe bosses 14d) are provided for the intake pipe 14a. In the present embodiment, both the pipe flange 14c and the pipe bosses 14d extend in a height direction Y from the intake pipe 14a.

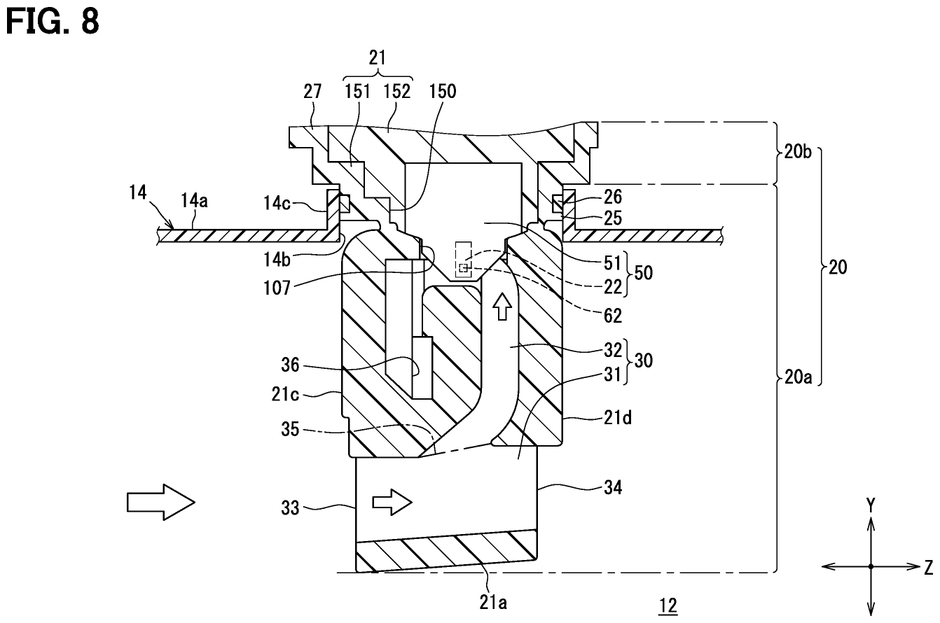

The air flow meter 20 is inserted into the pipe flange 14c and the airflow insertion hole 14b such that the air flow meter 20 enters the intake passage 12 while the air flow meter 20 is fixed to the pipe boss 14d via a fixing tool such as a bolt. The air flow meter 20 is not in contact with an end surface of the pipe flange 14c, but is in contact with an end surface of the pipe boss 14d. Therefore, the relative position and angle of the air flow meter 20 with respect to the piping unit 14 are set not by the pipe flange 14c but by the pipe boss 14d. The end surfaces of the multiple pipe bosses 14d are coplanar with each other. In FIG. 8, illustration of the pipe bosses 14d are omitted.

In the present embodiment, a width direction X, the height direction Y, and a depth direction Z are defined for the air flow meter 20, and those directions X, Y, and Z are orthogonal to each other. The air flow meter 20 extends in the height direction Y, and the intake passage 12 extends in the depth direction Z. The air flow meter 20 includes an inward portion 20a positioned in the intake passage 12 and an outward portion 20b protruding outward from the pipe flange 14c without being in the intake passage 12, and the inward portion 20a and the outward portion 20b are aligned in the height direction Y.

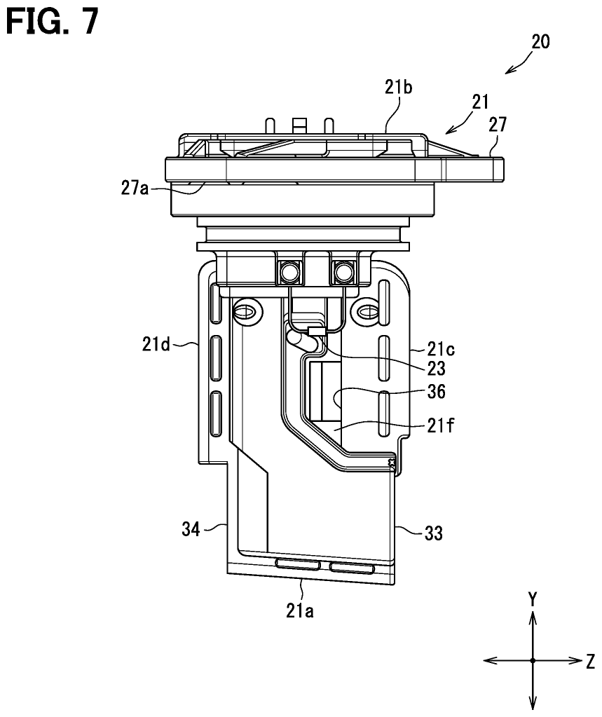

As shown in FIGS. 2, 4, 7 and 8, the air flow meter 20 includes a housing 21, a flow rate sensor 22 that detects a flow rate of the intake air, and an intake air temperature sensor 23 that detects a temperature of the intake air. The housing 21 is made of, for example, a resin material. The flow rate sensor 22 is accommodated in the housing 21. The housing 21 of the air flow meter 20 is attached to the intake pipe 14a such that the flow rate sensor 22 can come in contact with the intake air flowing through the intake passage 12.

The housing 21 is attached to the piping unit 14 as an attachment object. An outer surface of the housing 21 includes a pair of end surfaces 21a and 21b opposite in the height direction Y. One of the pair of end surfaces 21a and 21b included in the inward portion 20a is referred to as a housing distal end surface 21a, and another included in the outward portion 20b is referred to as a housing basal end surface 21b. The housing distal end surface 21a and the housing basal end surface 21b are orthogonal to the height direction Y. An end surface of the pipe flange 14c is also orthogonal to the height direction Y. The attachment object to which the air flow meter 20 and the housing 21 are attached may not be the piping unit 14 as long as the attachment object is a forming member that forms the intake passage 12.

A surface of the outer surface of the housing 21 facing upstream in the intake passage 12 is referred to as a housing upstream surface 21c, and a surface of the outer surface of the housing 21 opposite the housing upstream surface 21c is referred to as a housing downstream surface 21d. In addition, one of a pair of opposite surfaces of the housing 21 facing each other along the housing upstream surface 21c and the housing basal end surface 21b is referred to as a housing front surface 21e, and the other is referred to as a housing back surface 21f. The housing front surface 21e and a surface of a sensor SA 50 on which the flow rate sensor 22 is provided face in the same direction.

Regarding the housing 21, a direction in which the housing distal end surface 21a faces in the height direction Y is referred to as a housing distal end direction, and a direction in which the housing basal end surface 21b faces in the height direction Y is referred to as a housing basal end direction. Further, a direction in which the housing upstream surface 21c faces in the depth direction Z is referred to as a housing upstream direction, and a direction in which the housing downstream surface 21d faces in the depth direction Z is referred to as a housing downstream direction. Further, a direction in which the housing front surface 21e faces in the width direction X is referred to as a housing front direction, and a direction in which the housing back surface 21f faces in the width direction X is referred to as a housing back direction.

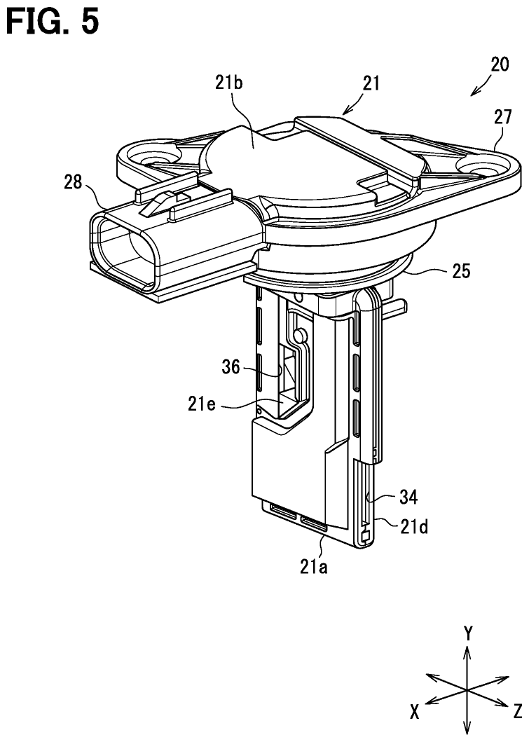

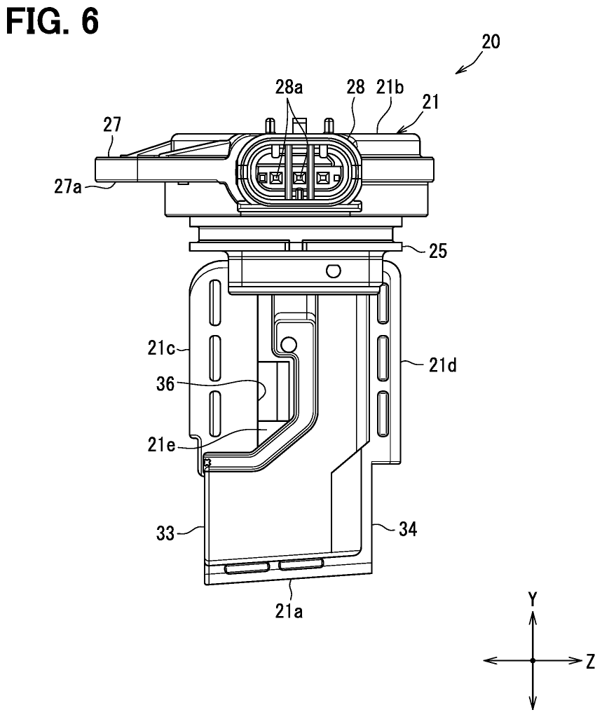

As shown in FIGS. 2 to 7, the housing 21 includes a seal holder 25, a flange 27 and a connector 28. The air flow meter 20 includes a seal member 26, and the seal member 26 is attached to the seal holder 25.

The seal holder 25 is provided inside the pipe flange 14c and holds the seal member 26 so as not to be displaced in the height direction Y. The seal holder 25 is included in the inward portion 20a of the air flow meter 20. The seal member 26 is a member such as an O-ring that is inside the pipe flange 14c and seals the intake passage 12. The seal member 26 is in tight contact with both an outer peripheral surface of the seal holder 25 and an inner peripheral surface of the pipe flange 14c.

The flange 27 has a fixing hole such as a screw hole for fixing a fixing tool such as a screw. The fixing tool is used for fixing the housing 21 to the intake pipe 14a. A surface of the flange 27 facing in the housing distal end direction is overlapped and in contact with an end surface of the pipe boss 14d, and this overlapped portion is referred to as an angle setting surface 27a. Both the angle setting surface 27a and the end surface of the pipe boss 14d extend in a direction orthogonal to the height direction Y, and extend in the width direction X and the depth direction Z. The end surface of the pipe boss 14d sets the position and angle of the angle setting surface 27a relative to the intake pipe 14a. The angle setting surface 27a sets the position and angle of the housing 21 relative to the intake pipe 14a in the air flow meter 20.

In the intake pipe 14a of the piping unit 14, a main flow of air flowing through the intake passage 12 is along the depth direction Z. A direction of the main flow is called a main flow direction, and the depth direction Z coincides with the main flow direction. In the housing 21, the angle setting surface 27a of the flange 27 extends in the main flow direction and the depth direction Z. The end surface of the pipe boss 14d also extends in the main flow direction and the depth direction Z.

The connector 28 is a protection portion for protecting a connector terminal 28a electrically connected to the flow rate sensor 22. The connector terminal 28a is electrically connected to the ECU 15. More specifically, an electrical wiring extending from the ECU 15 is connected to the connector 28 via a plug or the like. The flange 27 and the connector 28 are included in the outward portion 20b of the air flow meter 20.

As shown in FIG. 8, the intake air temperature sensor 23 is provided outside the housing 21. The intake air temperature sensor 23 includes a temperature sensing element for sensing a temperature of the intake air, a lead wire extending from the temperature sensing element, and an intake air temperature terminal connected to the lead wire. The housing 21 includes a support portion that supports the intake air temperature sensor 23, and the support portion is provided on an outer peripheral side of the housing 21.

The housing 21 includes a bypass flow path 30. The bypass flow path 30 is provided inside the housing 21. The bypass flow path 30 includes at least a part of an internal space of the housing 21. An inner surface of the housing 21 is a forming surface and forms the bypass flow path 30.

The bypass flow path 30 is disposed in the inward portion 20a of the air flow meter 20. The bypass flow path 30 includes a through flow path 31 and a measurement flow path 32. The flow rate sensor 22 and its surrounding portions of the sensor SA 50, which will be described later, are in the measurement flow path 32. The through flow path 31 is formed by the inner surface of the housing 21. The measurement flow path 32 is formed by the inner surface of the housing 21 and the outer surface of a part of the sensor SA 50. The intake passage 12 may be referred to as a main passage, and the bypass flow path 30 may be referred to as a sub-passage.

The through flow path 31 penetrates through the housing 21 in the depth direction Z. The through flow path 31 includes a through inlet 33 that is an upstream end part of the through flow path 31, and a through outlet 34 that is a downstream end part of the through flow path 31. The measurement flow path 32 is a branch flow path branched from an intermediate part of the through flow path 31. The flow rate sensor 22 is provided in the measurement flow path 32. The measurement flow path 32 has a measurement inlet 35 which is an upstream end part of the measurement flow path 32, and a measurement outlet 36 which is a downstream end part of the measurement flow path 32. A boundary between the through flow path 31 and the measurement flow path 32 is a portion where the measurement flow path 32 branches from the through flow path 31. The measurement inlet 35 is included in the boundary. The boundary between the through flow path 31 and the measurement flow path 32 may also be referred to as a flow path boundary. The measurement inlet 35 faces in the housing distal end direction while being inclined so as to face toward the measurement outlet 36.

The measurement flow path 32 extends from the through flow path 31 in the housing basal end direction. The measurement flow path 32 is provided between the through flow path 31 and the housing basal end surface 21b. The measurement flow path 32 is curved so that a portion between the measurement inlet 35 and the measurement outlet 36 bulges in the housing basal end direction. The measurement flow path 32 includes an arched portion that curves continuously, a bent portion that bends in a stepwise manner, and a portion that extends straight in the height direction Y or the depth direction Z.

The flow rate sensor 22 is a thermal flow rate detection unit having a heater. The flow rate sensor 22 outputs a detection signal according to a temperature change caused by heat generation of the heater. The flow rate sensor 22 is a rectangular parallelepiped chip component, and the flow rate sensor 22 may also be referred to as a sensor chip. The flow rate sensor 22 may also be referred to as a physical quantity sensor or a physical quantity detection unit that detects a flow rate of intake air as a physical quantity of a fluid.

The air flow meter 20 has a sensor sub-assembly including the flow rate sensor 22, and the sensor sub-assembly is referred to as the sensor SA 50. The sensor SA 50 is embedded in the housing 21 while a part of the sensor SA 50 extending into the measurement flow path 32. In the air flow meter 20, the sensor SA 50 and the bypass flow path 30 are arranged in the height direction Y. More specifically, the sensor SA 50 and the through flow path 31 are arranged in the height direction Y. The sensor SA 50 corresponds to a detection unit. The sensor SA 50 may also be referred to as a measurement unit or a sensor package.

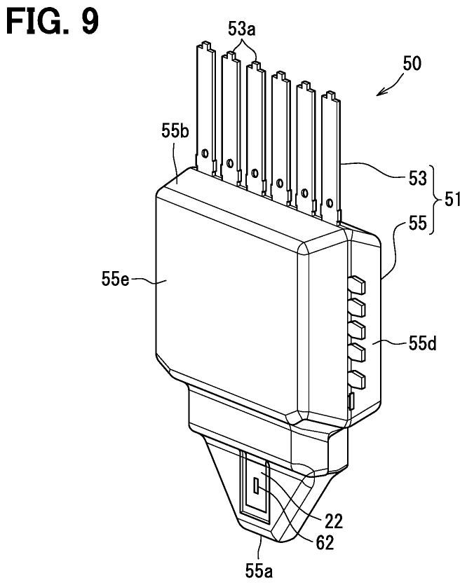

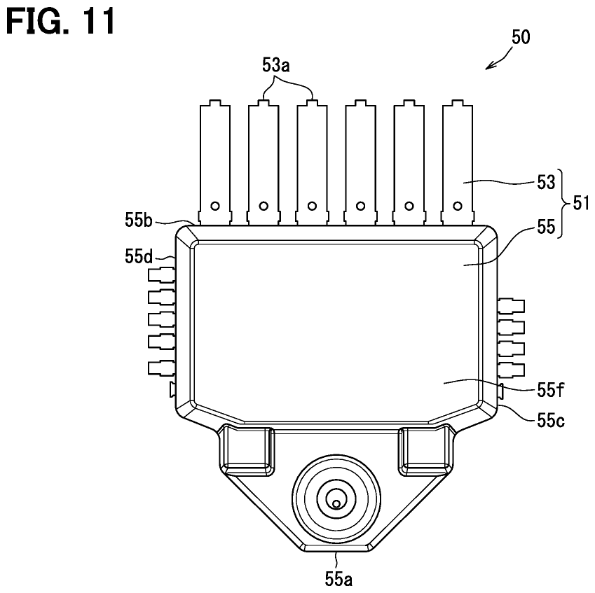

As shown in FIGS. 9, 10 and 11, the sensor SA 50 includes a sensor support 51 in addition to the flow rate sensor 22. The sensor support 51 is attached to the housing 21 and supports the flow rate sensor 22. The sensor support 51 includes an SA substrate 53 and a molded portion 55. The SA substrate 53 is a substrate on which the flow rate sensor 22 is mounted. The molded portion 55 covers at least a part of the flow rate sensor 22 and at least a part of the SA substrate 53. The SA substrate 53 may also be called a lead frame.

The molded portion 55 is formed in a plate shape as a whole. An outer surface of the molded portion 55 includes a pair of end surfaces 55a and 55b opposite in the height direction Y. One of the pair of end surfaces 55a and 55b facing in the housing distal end direction is referred to as a molded distal end surface 55a, and the other facing in the housing basal end direction is referred to as a molded basal end surface 55b. The molded distal end surface 55a is an end part of the molded portion 55 and an end part of the sensor support 51, and corresponds to a support end portion. The molded portion 55 corresponds to a protective resin portion.

The outer surface of the molded portion 55 includes a pair of surfaces 55c, 55d facing each other across the molded distal end surface 55a and the molded basal end surface 55b. One of the pair of surfaces 55c, 55d is referred to as a molded upstream surface 55c, and the other is referred to as a molded downstream surface 55d. In FIG. 8, the sensor SA 50 is arranged inside the housing 21. The molded distal end surface 55a faces in a direction toward a tip end of the air flow meter 20. The molded upstream surface 55c is arranged upstream of the molded downstream surface 55d in the measurement flow path 32.

The molded upstream surface 55c of the sensor SA 50 is arranged upstream of the molded downstream surface 55d in the measurement flow path 32. A flow direction of air in a part of the measurement flow path 32 where the flow rate sensor 22 is disposed is opposite to a flow direction of air in the intake passage 12. Therefore, the molded upstream surface 55c is arranged downstream of the molded downstream surface 55d in the intake passage 12. The air flowing along the flow rate sensor 22 flows in the depth direction Z, and this depth direction Z may also be referred to as a flow direction.

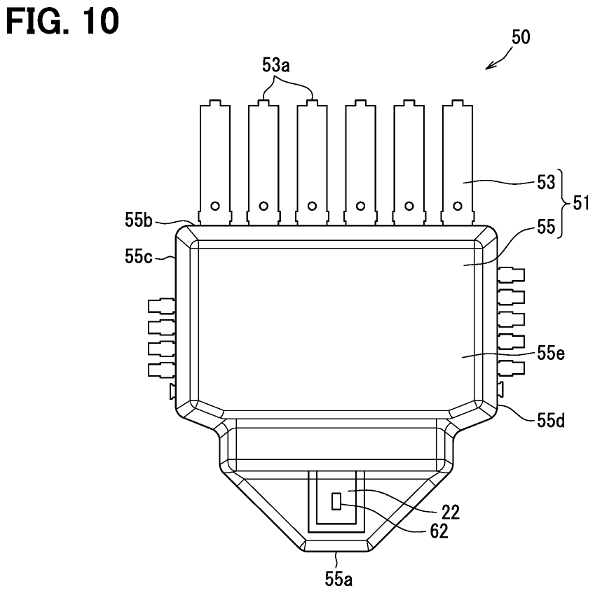

As shown in FIGS. 9 and 10, in the sensor SA 50, the flow rate sensor 22 is exposed on one side of the sensor SA 50. The outer surface of the mold molded portion 55 includes a plate surface referred to as a molded front surface 55e on the same side as the flow rate sensor 22 being exposed, and a plate surface referred to as a molded back surface 55f opposite the molded front surface 55e. One of the plate surfaces of the sensor SA 50 is formed by the molded front surface 55e. The molded front surface 55e corresponds to a support front surface, and the molded back surface 55f corresponds to a support back surface.

The SA substrate 53 is formed of a metal material or the like in a plate shape as a whole, and is a conductive substrate. A plate surface of the SA substrate 53 is orthogonal to the width direction X and extends in the height direction Y and the depth direction Z. The flow rate sensor 22 is mounted on the SA substrate 53. The SA substrate 53 forms a lead terminal 53a connected to the connector terminal 28a. The SA substrate 53 has a part covered by the molded portion 55 and a part not covered by the molded portion 55, and the part not covered is the lead terminal 53a. The lead terminal 53a projects in the height direction Y from the molded basal end surface 55b. In FIG. 8, illustration of the lead terminal 53a is omitted.

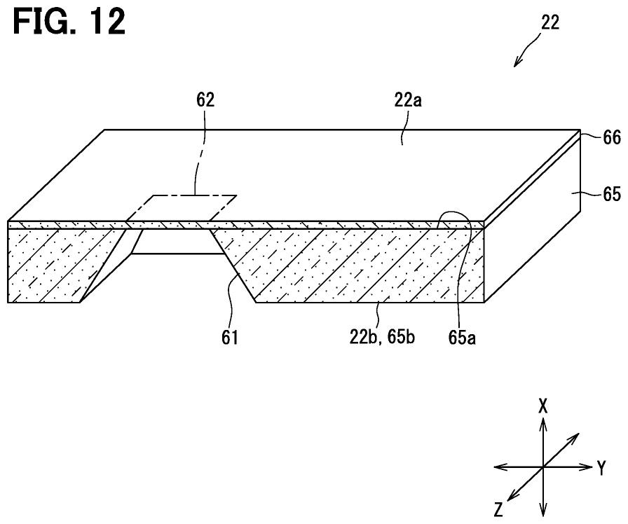

As shown in FIG. 12, the flow rate sensor 22 is formed in a plate shape as a whole. The flow rate sensor 22 has a sensor front surface 22a as one surface, and a sensor back surface 22b opposite the sensor front surface 22a. In the flow rate sensor 22, the sensor back surface 22b faces the SA substrate 53, and a part of the sensor front surface 22a is exposed to an outside of the sensor SA 50.

The flow rate sensor 22 includes a sensor recess portion 61 and a membrane portion 62. The sensor recess portion 61 is provided on the sensor back surface 22b, and the membrane portion 62 is provided on the sensor front surface 22a. The membrane portion 62 forms a bottom surface of the sensor recess portion 61. The part of the membrane portion 62 that forms the bottom surface of the sensor recess portion 61 is a bottom part of the sensor recess portion 61. The sensor recess portion 61 is formed by the sensor back surface 22b being recessed toward the sensor front surface 22a. An opening of the sensor recess portion 61 is provided on the sensor back surface 22b. The membrane portion 62 is a sensing portion that senses a flow rate.

The flow rate sensor 22 includes a sensor substrate 65 and a sensor film 66. The sensor substrate 65 is a base material of the flow rate sensor 22 and is formed in a plate shape from a semiconductor material such as silicon. The sensor substrate 65 includes a substrate front surface 65a as one surface, and a substrate back surface 65b opposite the substrate front surface 65a. The sensor substrate 65 has a through hole penetrating through the sensor substrate 65 in the width direction X. The sensor recess portion 61 is formed by this through hole. The sensor substrate 65 may have a recess that forms the sensor recess portion 61 instead of the through hole. In this case, the bottom surface of the sensor recess portion 61 is not formed by the membrane portion 62 but by a bottom surface of the recess of the sensor substrate 65.

The sensor film 66 is overlaid on the substrate front surface 65a of the sensor substrate 65 and extends in a film shape along the substrate front surface 65a. In the flow rate sensor 22, the sensor front surface 22a is formed by the sensor film 66, and the sensor back surface 22b is formed by the sensor substrate 65. In this case, the sensor back surface 22b is the substrate back surface 65b of the sensor substrate 65.

The sensor film 66 has a multilayer structure including multiple layers such as an insulating layer, a conductive layer, and a protective layer. Each of these is formed in a film shape and extends along the substrate front surface 65a. The sensor film 66 has a wiring pattern such as wiring and resistors, and this wiring pattern is formed by a conductive layer.

In the flow rate sensor 22, the sensor recess portion 61 is formed by processing a part of the sensor substrate 65 by wet etching. In the manufacturing process of the flow rate sensor 22, a mask such as a silicon nitride film is attached to the substrate back surface 65b of the sensor substrate 65, and anisotropic etching is performed on the substrate back surface 65b using an etching solution until the sensor film 66 is exposed. The sensor recess portion 61 may be formed by performing dry etching on the sensor substrate 65.

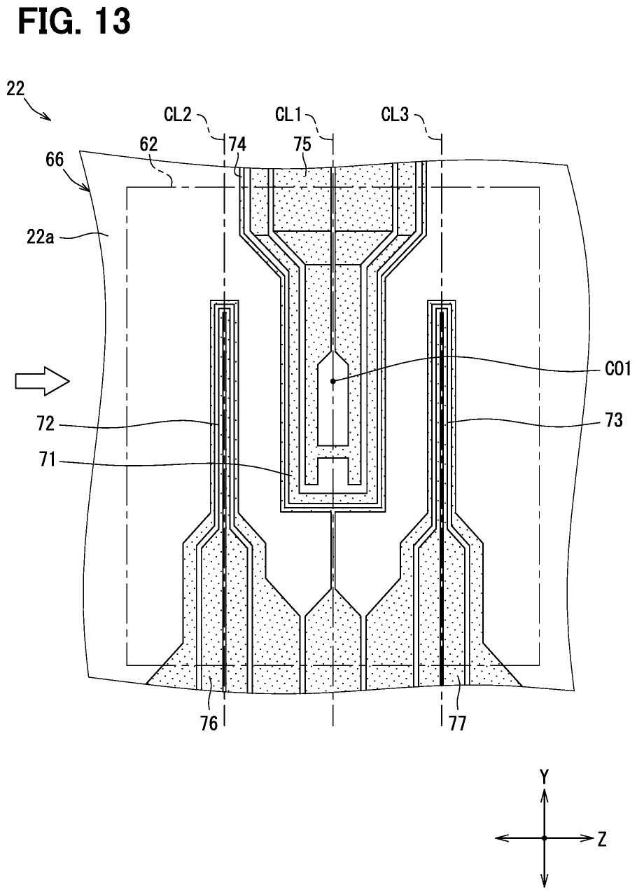

The sensor SA 50 has a flow rate detection circuit that detects a flow rate of air. At least a part of this flow rate detection circuit is included in the flow rate sensor 22. As shown in FIG. 13, the sensor SA 50 includes a heating resistor 71, temperature measuring resistors 72, 73, and an indirectly heated resistor 74 as circuit elements included in the flow rate detection circuit. These resistors 71 to 74 are included in the flow rate sensor 22 and are formed by the conductive layer of the sensor film 66. In this case, the sensor film 66 includes the resistors 71 to 74, and these resistors 71 to 74 are included in the wiring pattern of the conductive layer. In FIG. 13, the wiring pattern including the resistors 71 to 74 is illustrated by dot hatching. The flow rate detection circuit may also be referred to as a flow rate measurement unit that measures the flow rate of air.

The heating resistor 71 is a resistance element that generates heat according to energization of the heating resistor 71. The heating resistor 71 generates heat to heat the sensor film 66, and corresponds to a heater. The temperature measuring resistors 72, 73 are resistance elements for detecting a temperature of the sensor film 66, and correspond to a temperature detection portion. The resistance values of the temperature measuring resistors 72, 73 change according to the temperature of the sensor film 66. In the flow rate detection circuit, the temperature of the sensor film 66 is detected using the resistance values of the temperature measuring resistors 72, 73. The flow rate detection circuit raises the temperature of the sensor film 66 and the temperatures of the temperature measuring resistors 72 and 73 by the heating resistor 71. When an air flow occurs in the measurement flow path 32, the flow rate detection circuit detects an air flow rate and a flow direction by using change in temperature detected by the temperature measuring resistors 72, 73.

The heating resistor 71 is arranged substantially at the center of the membrane portion 62 in each of the height direction Y and the depth direction Z. The heating resistor 71 is formed in a rectangular shape extending in the height direction Y as a whole. The center line CL1 of the heating resistor 71 passes through the center CO1 of the heating resistor 71 and extends linearly in the height direction Y. The center line CL1 passes through the center of the membrane portion 62. The heating resistor 71 is arranged at a position spaced inward from a peripheral edge of the membrane portion 62. An end of the heating resistor 71 facing in a molded distal end direction and an end of the heating resistor 71 facing in a molded basal end direction are the same in distance from the center CO1.

Each of the temperature measuring resistors 72, 73 is formed in a rectangular shape extending in the height direction Y as a whole. The temperature measuring resistors 72, 73 are arranged in the depth direction Z. The heating resistor 71 is disposed between the temperature measuring resistors 72, 73. An upstream temperature measuring resistor 72 among the temperature measuring resistors 72, 73 is provided at a position separated from the heating resistor 71 in a molded upstream direction. A downstream temperature measuring resistor 73 among the temperature measuring resistors 72, 73 is provided at a position separated from the heating resistor 71 in a molded downstream direction. The center line CL2 of the upstream temperature measuring resistor 72 and the center line CL3 of the downstream temperature measuring resistor 73 both linearly extend parallel to the center line CL1 of the heating resistor 71. The heating resistor 71 is disposed at an intermediate position between the upstream temperature measuring resistor 72 and the downstream temperature measuring resistor 73 in the depth direction Z.

Regarding the sensor SA 50 of the present embodiment, in FIG. 10, a direction in which the molded upstream surface 55c faces is referred to as the molded upstream direction, and a direction in which the molded downstream surface 55d faces is referred to as the molded downstream direction. Further, a direction in which the molded distal end surface 55a faces is referred to as the molded distal end direction, and a direction in which the molded basal end surface 55b faces is referred to as the molded basal end direction.

Returning to the explanation of FIG. 13, the indirectly heated resistor 74 is a resistance element for detecting a temperature of the heating resistor 71. The indirectly heated resistor 74 extends along the peripheral edge of the heating resistor 71. A resistance value of the indirectly heated resistor 74 changes according to the temperature of the heating resistor 71. In the flow rate detection circuit, the temperature of the heating resistor 71 is detected using the resistance value of the indirectly heated resistor 74.

The sensor SA 50 includes a heating wire 75 and temperature measuring wires 76. 77. These wires 75 to 77 are included in the wiring pattern of the sensor film 66, like the resistors 71 to 74. The heating wire 75 extends from the heating resistor 71 in the molded basal end direction along the height direction Y. The upstream temperature measuring wire 76 extends from the upstream temperature measuring resistor 72 in the molded distal end direction along the height direction Y. The downstream temperature measuring wire 77 extends from the downstream temperature measuring resistor 73 in the molded distal end direction along the height direction Y.

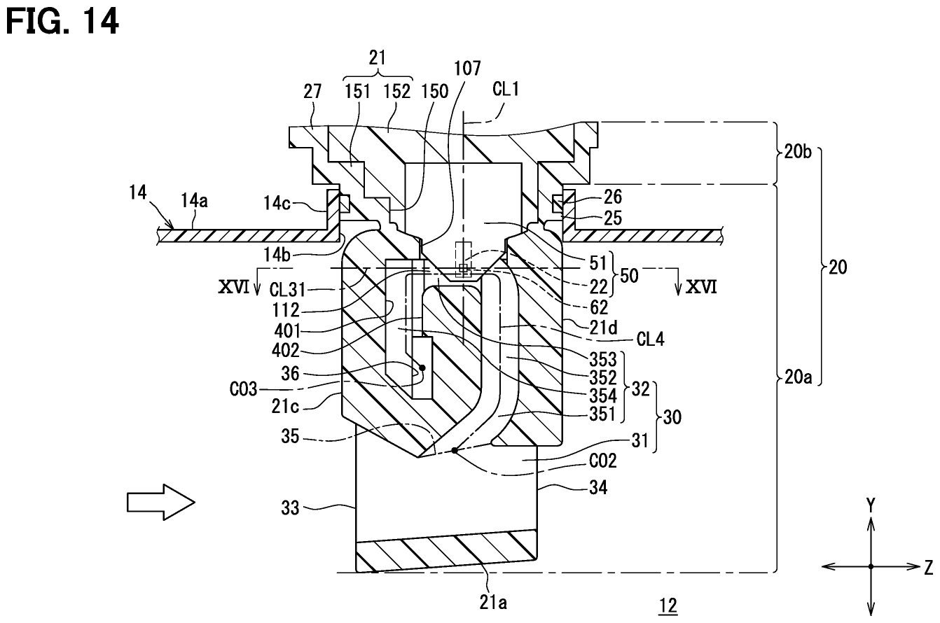

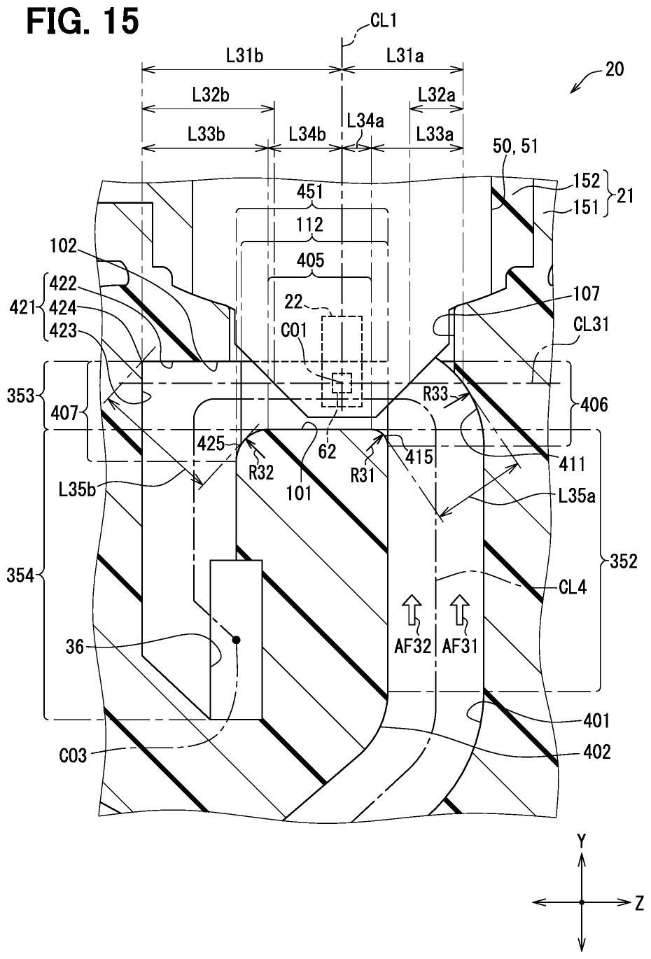

As shown in FIGS. 14 and 15, a center line CL4 of the measurement flow path 32 passes through a center CO2 of the measurement inlet 35 and a center CO3 of the measurement outlet 36, and extends linearly along the measurement flow path 32. The sensor SA 50 is provided in the measurement flow path 32 between the measurement inlet 35 and the measurement outlet 36. The sensor SA 50 is disposed at a position downstream away from the measurement inlet 35 and upstream away from the measurement outlet 36. In FIGS. 14 and 15, a center line of a region of the measurement flow path 32 excluding an internal space of a SA insertion hole 107 is shown as the center line CL4.

As shown in FIGS. 15 to 17, the housing 21 includes a measurement floor surface 101, a measurement ceiling surface 102, a front measurement wall surface 103, and a back measurement wall surface 104 as formation surfaces forming the measurement flow path 32. The measurement floor surface 101, the measurement ceiling surface 102, the front measurement wall surface 103, and the back measurement wall surface 104 all extend along the center line CL4 of the measurement flow path 32. The measurement floor surface 101, the measurement ceiling surface 102, the front measurement wall surface 103, and the back measurement wall surface 104 form a part of the measurement flow path 32 extending in the depth direction Z. The measurement floor surface 101 corresponds to a floor surface, the front measurement wall surface 103 corresponds to a front wall surface, and the back measurement wall surface 104 corresponds to a back wall surface. The width direction X corresponds to a front and back direction in which the front wall surface and the back wall surface faces each other.

The measurement floor surface 101 and the measurement ceiling surface 102 are provided between the front measurement wall surface 103 and the back measurement wall surface 104. The measurement floor surface 101 faces the molded distal end surface 55a of the sensor SA 50 and extends straight in the depth direction Z. The measurement ceiling surface 102 is opposite and facing to the measurement floor surface 101 across the center line CL4 in the height direction Y. The SA insertion hole 107 is provided in a portion of the housing 21 that forms the measurement ceiling surface 102, and the sensor SA 50 is inserted into the SA insertion hole 107. The SA insertion hole 107 is closed by the sensor SA 50. The measurement flow path 32 also includes a gap between the sensor SA 50 and the housing 21 in the internal space of the SA insertion hole 107.

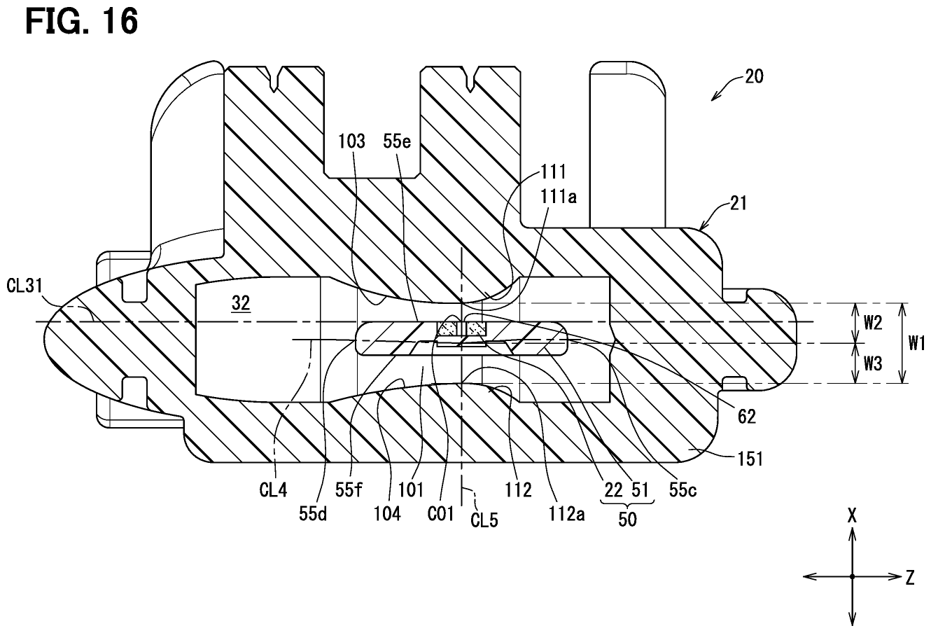

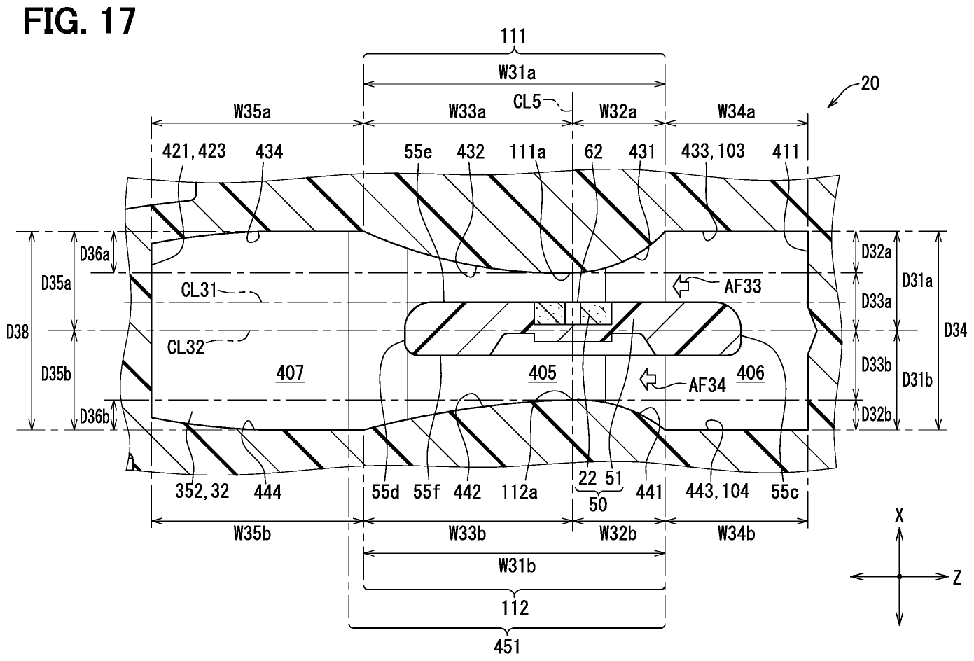

The front measurement wall surface 103 and the back measurement wall surface 104 are a pair of wall surfaces facing each other across the measurement floor surface 101 and the measurement ceiling surface 102. The front measurement wall surface 103 faces the molded front surface 55e of the sensor SA 50, and extends in the housing basal end direction from an edge of the measurement floor surface 101 on an airflow-meter front side. The front measurement wall surface 103 faces the flow rate sensor 22 of the sensor SA 50. The back measurement wall surface 104 faces the molded back surface 55f of the sensor SA 50, and extends in the housing basal end direction from an edge of the measurement floor surface 101 on an airflow-meter back side. In FIGS. 16 and 17, the internal structure of the sensor SA 50 is simplified and only the molded portion 55 and the flow rate sensor 22 are shown.

The housing 21 has a front narrowed portion 111 and a back narrowed portion 112. These narrowed portions 111, 112 gradually narrow the measurement flow path 32 such that the cross-sectional area of the measurement flow path 32 gradually decreases from an upstream part such as the measurement inlet 35 in a direction toward the flow rate sensor 22. Further, the narrowed portions 111, 112 gradually narrow the measurement flow path 32 such that the cross-sectional area of the measurement flow path 32 gradually decreases from a downstream part such as the measurement outlet 36 in a direction toward the flow rate sensor 22. Regarding the measurement flow path 32, an area orthogonal to the center line CL4 is referred to as a cross-sectional area, and this cross-sectional area may also be referred to as a flow path area.

The front narrowed portion 111 is a convex portion in which a part of the front measurement wall surface 103 protrudes toward the back measurement wall surface 104. The back narrowed portion 112 is a convex portion in which a part of the back measurement wall surface 104 protrudes toward the front measurement wall surface 103. The front narrowed portion 111 and the back narrowed portion 112 are arranged along the height direction Y and face each other in the width direction X. These narrowed portions 111, 112 are bridged by the measurement ceiling surface 102 and the measurement floor surface 101. The narrowed portions 111, 112 gradually reduce a measurement width dimension W1 (see FIG. 16) in a direction from upstream to the flow rate sensor 22. The measurement width dimension W1 is a distance in the width direction X between the front measurement wall surface 103 and the back measurement wall surface 104. Further, the narrowed portions 111, 112 gradually reduce the measurement width dimension W1 in a direction from downstream to the flow rate sensor 22.

The narrowed portions 111, 112 gradually approach the center line CL4 in the direction from upstream to the flow rate sensor 22 in the measurement flow path 32. In the measurement flow path 32, the distances W2, W3 in the width direction X between the narrowed portions 111, 112 and the center line CL4 gradually decrease in the direction from upstream to the flow rate sensor 22. The narrowed portions 111, 112 gradually approach the center line CL4 in the direction from downstream to the flow rate sensor 22 in the measurement flow path 32. In the measurement flow path 32, the distances W2, W3 in the width direction X between the narrowed portions 111, 112 and the center line CL4 gradually decrease in the direction from downstream to the flow rate sensor 22.

In the narrowed portions 111, 112, the parts closest to the center line CL4 are peaks 111a, 112a. In this case, in the narrowed portions 111, 112, the distances W2, W3 from the center line CL4 are smallest at the peaks 111a, 112a. The peaks 111a, 112a are a front peak 111a of the front narrowed portion 111 and a back peak 112a of the back narrowed portion 112. The front peak 111a and the back peak 112a are arranged in the width direction X and face each other.

The flow rate sensor 22 is disposed between the front narrowed portion 111 and the back narrowed portion 112. More specifically, the center CO1 of the heating resistor 71 of the flow rate sensor 22 is provided between the front peak 111a and the back peak 112a. Regarding the heating resistor 71, a center line CL5 is defined as a straight imaginary line that passes through the center CO1, is orthogonal to the center line CL1 and extends in the width direction X. Both the front peak 111a and the back peak 112a are located on the center line CL5. In this case, the center CO1 of the heating resistor 71 and the front peak 111a are aligned in the width direction X. The center CO1 of the heating resistor 71 and the front peak 111a face each other in the width direction X.

As shown in FIGS. 8 and 14, the housing 21 includes an SA container space 150. The bypass flow path 30 and the SA container space 150 are arranged in this order in the housing basal end direction. The SA container space 150 houses a part of the sensor SA 50. At least the molded basal end surface 55b of the sensor SA 50 is housed in the SA container space 150. The measurement flow path 32 and the SA container space 150 are arranged in the height direction Y. The sensor SA 50 is positioned to extend in the height direction Y across a boundary between the measurement flow path 32 and the SA container space 150. At least the molded distal end surface 55a and the flow rate sensor 22 of the sensor SA 50 are housed in the measurement flow path 32. The SA container space 150 corresponds to a container space.

The housing 21 includes a first housing part 151 and a second housing part 152. The housing parts 151 and 152 are assembled and integrated with each other so as to form the housing 21. The first housing part 151 forms the SA container space 150. The first housing part 151 forms the bypass flow path 30 in addition to the SA container space 150. An inner surface of the first housing part 151 that is an inner surface of the housing 21 defines the SA container space 150 and the bypass flow path 30.

As shown in FIGS. 14 and 15, the measurement flow path 32 is curved so that the portion between the measurement inlet 35 and the measurement outlet 36 bulges toward the flow rate sensor 22. The measurement flow path 32 has a U shape as a whole. In the measurement flow path 32, the measurement inlet 35 and the measurement outlet 36 are arranged in the depth direction Z. In this case, the depth direction Z corresponds to an arrangement direction, and the height direction Y is orthogonal to the depth direction Z. In the measurement flow path 32, the portion between the measurement inlet 35 and the measurement outlet 36 is curved to bulge in the housing basal end direction along the height direction Y.

The inner surface of the housing 21 includes an outer measurement curved surface 401 and an inner measurement curved surface 402. The outer measurement curved surface 401 and the inner measurement curved surface 402 extend along the center line CL4 of the measurement flow path 32. The inner surface of the housing 21 includes the front measurement wall surface 103 and the back measurement wall surface 104 as described above, in addition to the outer measurement curved surface 401 and the inner measurement curved surface 402. The outer measurement curved surface 401 and the inner measurement curved surface 402 face each other in the directions Y and Z orthogonal to the width direction X. The outer measurement curved surface 401 and the inner measurement curved surface 402 face each other across the front measurement wall surface 103 and the back measurement wall surface 104.

The outer measurement curved surface 401 defines an outer outline of a curved part of the measurement flow path 32. The outer measurement curved surface 401 is provided circumferentially outward of the measurement flow path 32 and the flow rate sensor 22. The outer measurement curved surface 401 connects the measurement inlet 35 and the measurement outlet 36. The outer measurement curved surface 401 is concavely curved such that the portion between the measurement inlet 35 and the measurement outlet 36 is concaved toward the flow rate sensor 22 as a whole. The outer measurement curved surface 401 includes the measurement ceiling surface 102. The SA insertion hole 107 is provided on the outer measurement curved surface 401.

The inner measurement curved surface 402 defines an inner outline of the curved part of the measurement flow path 32. The inner measurement curved surface 402 is provided circumferentially inward of the measurement flow path 32. The inner measurement curved surface 402 connects the measurement inlet 35 and the measurement outlet 36. The inner measurement curved surface 402 is curved such that the portion between the measurement inlet 35 and the measurement outlet 36 bulges toward the flow rate sensor 22 as a whole. The inner measurement curved surface 402 does not have a portion concaved in a direction away from the outer measurement curved surface 401. The whole of the inner measurement curved surface 402 is curved in a convex shape so as to bulge toward the outer measurement curved surface 401. The inner measurement curved surface 402 includes the measurement floor surface 101.

As shown in FIG. 15, the measurement flow path 32 includes a sensor path 405, an upstream curved path 406, and a downstream curved path 407. The sensor path 405 is a portion of the measurement flow path 32 where the flow rate sensor 22 is provided. The sensor path 405 extends straight in the depth direction Z. The sensor path 405 extends in the main flow direction parallel to the angle setting surface 27a of the flange 27. The upstream curved path 406 and the downstream curved path 407 are arranged in the depth direction Z. The sensor path 405 is provided between the upstream curved path 406 and the downstream curved path 407. The sensor path 405 connects these curved paths 406 and 407.

A surface of the housing 21 defining the sensor path 405 includes at least a part of the measurement floor surface 101. In this embodiment, a length of the sensor path 405 in the depth direction Z is defined by the measurement floor surface 101. Specifically, an upstream end part of the measurement floor surface 101 is included in an upstream end part of the sensor path 405. A downstream end part of the measurement floor surface 101 is included in a downstream end part of the sensor path 405. In this case, the length of the sensor path 405 in the depth direction Z is the same as the length of the measurement floor surface 101. The surface of the housing 21 defining the sensor path 405 includes not only the part of the measurement floor surface 101 but also a part of the measurement ceiling surface 102, a part of the front measurement wall surface 103, and a part of the back measurement wall surface 104. In the present embodiment, the measurement floor surface 101 extends straight in the depth direction Z. Since the measurement floor surface 101 extends straight in this way, it can be said that the sensor path 405 extends straight.

The upstream curved path 406 extends from the sensor path 405 toward the measurement inlet 35 in the measurement flow path 32. The upstream curved path 406 is provided between the sensor path 405 and the measurement inlet 35. The upstream curved path 406 is curved in the housing 21 such that the upstream curved path 406 extends from the sensor path 405 toward the measurement inlet 35. A downstream end part of the upstream curved path 406 faces and is open in the depth direction Z to the sensor path 405. An upstream end part of the upstream curved path 406 faces and is open in the height direction Y to the measurement inlet 35. In the upstream curved path 406, the open direction of the upstream end part intersects with the open direction of the downstream end part, and the intersection angle is 90 degrees, for example. An inner surface of the upstream curved path 406 includes a part of the front measurement wall surface 103 and a part of the back measurement wall surface 104.

The downstream curved path 407 extends from the sensor path 405 toward the measurement outlet 36 in the measurement flow path 32. The downstream curved path 407 is provided between the sensor path 405 and the measurement outlet 36. The downstream curved path 407 is curved in the housing 21 such that the downstream curved path 407 extends from the sensor path 405 toward the measurement outlet 36. An upstream end part of the downstream curved path 407 faces and is open in the depth direction Z to the sensor path 405. A downstream end part of the downstream curved path 407 faces and is open in the height direction Y to the measurement outlet 36. In the downstream curved path 407, similar to the upstream curved path 406, the open direction of the upstream end part intersects with the open direction of the downstream end part, and the intersection angle is 90 degrees, for example. An inner surface of the downstream curved path 407 includes a part of the front measurement wall surface 103 and a part of the back measurement wall surface 104.

In the measurement flow path 32, the sensor path 405 is included in a detection measurement path 353. The upstream curved path 406 is positioned to extend in the height direction Y across a boundary between an introduction measurement path 352 and the detection measurement path 353. In this case, the upstream curved path 406 includes a part of the introduction measurement path 352 and a part of the detection measurement path 353. The downstream curved path 407 is positioned to extend in the height direction Y across a boundary between the detection measurement path 353 and a discharge measurement path 354. In this case, the downstream curved path 407 includes a part of the detection measurement path 353 and a part of the discharge measurement path 354.

The inner surface of the housing 21 includes an upstream outer curved surface 411 and an upstream inner curved surface 415 which are surfaces defining the upstream curved path 406. The upstream outer curved surface 411 defines an outer outline of a curved part of the upstream curved path 406. The upstream outer curved surface 411 is provided circumferentially outward of the upstream curved path 406. The upstream outer curved surface 411 concavely extends along the center line CL4 of the measurement flow path 32. The upstream outer curved surface 411 is arched so as to be continuously curved along the center line CL4. The upstream outer curved surface 411 connects the upstream end part and the downstream end part of the upstream curved path 406. The upstream outer curved surface 411 corresponds to an upstream outer arched surface.

The upstream inner curved surface 415 defines an inner outline of the curved part of the upstream curved path 406. The upstream inner curved surface 415 is provided circumferentially inward of the upstream curved path 406. The upstream inner curved surface 415 convexly extends along the center line CL4 of the measurement flow path 32. The upstream inner curved surface 415 is arched so as to be continuously curved along the center line CL4. The upstream inner curved surface 415 connects the upstream end part and the downstream end part of the upstream curved path 406. The upstream inner curved surface 415 corresponds to an upstream inner arched surface. The inner surface of the housing 21 includes not only the upstream outer curved surface 411 and the upstream inner curved surface 415 but also a part of the front measurement wall surface 103 and a part of the back measurement wall surface 104 which are surfaces defining the upstream curved path 406.

The inner surface of the housing 21 includes a downstream outer curved surface 421 and an downstream inner curved surface 425 which are surfaces defining the downstream curved path 407. The downstream outer curved surface 421 defines an outer outline of a curved part of the downstream curved path 407. The downstream outer curved surface 421 is provided circumferentially outward of the downstream curved path 407. The downstream outer curved surface 421 extends along the center line CL4 of the measurement flow path 32. The downstream outer curved surface 421 is bent at a predetermined angle along the center line CL4. The bending angle of the downstream outer curved surface 421 is, for example, 90 degrees.

The downstream outer curved surface 421 includes a downstream outer horizontal surface 422, a downstream outer vertical surface 423, and a downstream outer internal corner 424. The downstream outer horizontal surface 422 extends straight downstream from the upstream end part of the downstream curved path 407 in the depth direction Z. The downstream outer vertical surface 423 extends straight upstream from the downstream end part of the downstream curved path 407 in the height direction Y. The downstream outer horizontal surface 422 and the downstream outer vertical surface 423 are connected to each other. The downstream outer horizontal surface 422 and the downstream outer vertical surface 423 join inwardly each other to form the downstream outer internal corner 424. The downstream outer internal corner 424 has a shape in which the downstream outer curved surface 421 is bent at a substantially right angle.

The downstream inner curved surface 425 defines an inner outline of the curved part of the downstream curved path 407. The downstream inner curved surface 425 is provided circumferentially inward of the downstream curved path 407. The downstream inner curved surface 425 convexly extends along the center line CL4 of the measurement flow path 32. The downstream inner curved surface 425 is arched so as to be continuously curved along the center line CL4. The downstream inner curved surface 425 connects the upstream end part and the downstream end part of the downstream curved path 407. The downstream inner curved surface 425 corresponds to a downstream inner arched surface. The inner surface of the housing 21 includes not only the downstream outer curved surface 421 and the downstream inner curved surface 425 but also a part of the front measurement wall surface 103 and a part of the back measurement wall surface 104 which are surfaces defining the downstream curved path 407.

In the measurement flow path 32, the outer measurement curved surface 401 includes the upstream outer curved surface 411 and the downstream outer curved surface 421. Each of the upstream outer curved surface 411 and the downstream outer curved surface 421 includes a part of the measurement ceiling surface 102. The inner measurement curved surface 402 includes not only the above-described measurement floor surface 101 but also the upstream inner curved surface 415 and the downstream inner curved surface 425.

In the measurement flow path 32, a degree of protrusion of the downstream inner curved surface 425 in a direction expanding the measurement flow path 32 is smaller than a degree of protrusion of the upstream inner curved surface 415 in the direction expanding the measurement flow path 32. Specifically, a length of the downstream inner curved surface 425 is larger than a length of the upstream inner curved surface 415 in a direction in which the center line CL4 of the measurement flow path 32 extends. In this case, a radius of curvature R32 of the downstream inner curved surface 425 is larger than a radius of curvature R31 of the upstream inner curved surface 415. That is, there is a relationship of R32>R31. In other words, the curve of the downstream inner curved surface 425 is gentler than the curve of the upstream inner curved surface 415.

In the measurement flow path 32, a degree of recess of the downstream outer curved surface 421 in the direction expanding the measurement flow path 32 is larger than a degree of recess of the upstream outer curved surface 411 in the direction expanding the measurement flow path 32. Specifically, the downstream outer curved surface 421 is bent at a right angle while the upstream outer curved surface 411 is arched. In this case, in the direction in which the center line CL4 of the measurement flow path 32 extends, a length of the bent portion of the downstream outer curved surface 421 is quite small and is smaller than a length of the upstream outer curved surface 411. If a radius of curvature can be calculated for the bent portion of the downstream outer curved surface 421, this radius of curvature is substantially zero and is smaller than the radius of curvature R33 of the upstream outer curved surface 411. In this case, the curve of the downstream outer curved surface 421 is sharper than the curve of the upstream outer curved surface 411.

In the upstream curved path 406, the degree of recess of the upstream outer curved surface 411 in the direction expanding the measurement flow path 32 is smaller than the degree of protrusion of the upstream inner curved surface 415 in the direction expanding the measurement flow path 32. Specifically, the length of the upstream outer curved surface 411 is larger than the length of the upstream inner curved surface 415 in the direction in which the center line CL4 of the measurement flow path 32 extends. In this case, the radius of curvature R33 of the upstream outer curved surface 411 is larger than the radius of curvature R31 of the upstream inner curved surface 415. That is, there is a relationship of R33>R31.

In the downstream curved path 407, the degree of recess of the downstream outer curved surface 421 in the direction expanding the measurement flow path 32 is larger than the degree of protrusion of the downstream inner curved surface 425 in the direction expanding the measurement flow path 32. Specifically, the length of the downstream outer curved surface 421 is smaller than the length of the downstream inner curved surface 425 in the direction in which the center line CL4 of the measurement flow path 32 extends. In this case, a radius of curvature R34 of the downstream outer curved surface 421 is smaller than the radius of curvature R32 of the downstream inner curved surface 425. That is, there is a relationship of R34<R32.

In the downstream curved path 407, the degree of recess of the downstream outer curved surface 421 is larger than the degree of protrusion of the downstream inner curved surface 425. Thus, a cross sectional area of the downstream curved path 407 becomes as large as possible in cross sectional area of the measurement flow path 32. Specifically, in a direction orthogonal to both the center line CL4 of the measurement flow path 32 and the width direction X, a distance L35b between the downstream outer curved surface 421 and the downstream inner curved surface 425 is larger than a distance L35a between the upstream outer curved surface 411 and the upstream inner curved surface 415. That is, there is a relationship of L35b>L35a.

The distance L35b between the downstream outer curved surface 421 and the downstream inner curved surface 425 is a distance at a portion of the downstream curved path 407 in which the downstream outer curved surface 421 and the downstream inner curved surface 425 are most distant from each other. The portion in which the downstream outer curved surface 421 and the downstream inner curved surface 425 are most distant from each other is, for example, a portion in which the downstream outer internal corner 424 of the downstream outer curved surface 421 and a center part of the downstream inner curved surface 425 face each other. The distance L35a between the upstream outer curved surface 411 and the upstream inner curved surface 415 is a distance at a portion of the upstream curved path 406 in which the upstream outer curved surface 411 and the upstream inner curved surface 415 are most distant from each other. The portion in which the upstream outer curved surface 411 and the upstream inner curved surface 415 are most distant from each other is, for example, a portion in which a center part of the upstream outer curved surface 411 and a center part of the upstream inner curved surface 415 face each other.

Regarding the measurement flow path 32, an arrangement line CL31 is defined as an imaginary straight line that passes through the flow rate sensor 22 and extends in the depth direction Z. The arrangement line CL31 passes through the center CO1 of the heating resistor 71 of the flow rate sensor 22 and is orthogonal to both the center lines CL1 and CL5 of the heating resistor 71. Regarding the arrangement line CL31, the depth direction Z corresponds to an arrangement direction in which the upstream curved path 406 and the downstream curved path 407 are arranged. In the sensor path 405, the arrangement line CL31 and the center line CL4 of the measurement flow path 32 are parallel to each other. The arrangement line CL31 extends parallel to the angle setting surface 27a of the housing 21.

The arrangement line CL31 passes through the sensor path 405, the upstream curved path 406 and the downstream curved path 407 and intersects with the upstream outer curved surface 411 and the downstream outer curved surface 421. In the downstream outer curved surface 421, the arrangement line CL31 intersects with the downstream outer vertical surface 423. The sensor path 405 extends straight along the arrangement line CL31. On the arrangement line CL31, a distance L31b between the flow rate sensor 22 and the downstream outer curved surface 421 is larger than a distance L31a between the flow rate sensor 22 and the upstream outer curved surface 411. That is, there is a relationship of L31b>L31a. Thus, the flow rate sensor 22 is provided at a position relatively near the upstream outer curved surface 411. The distances L31a, L31b are from the center line CL5 of the heating resistor 71.

In the sensor SA 50, the sensor support 51 is provided at the position relatively near to the upstream outer curved surface 411, so that the flow rate sensor 22 is provided at the position relatively near to the upstream outer curved surface 411. On the arrangement line CL31, a distance L32b between the sensor support 51 and the downstream outer curved surface 421 is larger than a distance L32a between the sensor support 51 and the upstream outer curved surface 411. That is, there is a relationship of L32b>L32a. In the measurement flow path 32, also out of the arrangement line CL31, a distance between the sensor support 51 and the downstream outer curved surface 421 is larger in the depth direction Z than a distance between the sensor support 51 and the upstream outer curved surface 411.

The sensor path 405 is provided between the upstream outer curved surface 411 and the downstream outer curved surface 421 at a position relatively near to the upstream outer curved surface 411. In this case, on the arrangement line CL31, a distance L33b between the sensor path 405 and the downstream outer curved surface 421 is larger than a distance L33a between the sensor path 405 and the upstream outer curved surface 411. That is, there is a relationship of L33b>L33a.

The flow rate sensor 22 is provided at a position relatively near the upstream curved path 406 in the sensor path 405. In this case, on the arrangement line CL31, a distance L34b between the flow rate sensor 22 and the downstream curved path 407 is larger than a distance L34a between the flow rate sensor 22 and the upstream curved path 406. That is, there is a relationship of L34b>L34a. The sum of the distance L34a and the distance L34b is the length of the sensor path 405 in the depth direction Z.

As described above, the housing 21 includes the narrowed portions 111, 112 shown in FIGS. 16 and 17. These narrowed portions 111, 112 are provided on the measurement wall surfaces 103, 104, and form a part of the measurement wall surfaces 103, 104.

The front measurement wall surface 103 includes a front narrowing surface 431, a front expanding surface 432, a front narrowing upstream surface 433, and a front expanding downstream surface 434. The front narrowing surface 431 and the front expanding surface 432 are formed by the front narrowed portion 111 and are included in an outer surface of the front narrowed portion 111. That is, the front narrowed portion 111 includes the front narrowing surface 431 and the front expanding surface 432. In the front narrowed portion 111, the front narrowing surface 431 extends in the depth direction Z from the front peak 111a toward the upstream curved path 406 while the front expanding surface 432 extends in the depth direction Z from the front peak 111a toward the downstream curved path 407. The front peak 111a is a boundary between the front narrowing surface 431 and the front expanding surface 432.

The front narrowing surface 431 is inclined with respect to the center line CL4 of the measurement flow path 32 in the detection measurement path 353. The front narrowing surface 431 faces toward the upstream outer curved surface 411. The front narrowing surface 431 gradually reduces and narrows the measurement flow path 32 in a direction from the measurement inlet 35 toward the flow rate sensor 22. The cross-sectional area of the measurement flow path 32 gradually decreases in a direction from an upstream end part of the front narrowing surface 431 toward the front peak 111a. The front narrowing surface 431 is arched such that a portion of the front narrowing surface 431 between the upstream end part and a downstream end part of the front narrowing surface 431 bulges toward the center line CL4 of the measurement flow path 32.

The front expanding surface 432 is inclined with respect to the center line CL4 of the measurement flow path 32 in the detection measurement path 353. The front expanding surface 432 faces toward the downstream outer curved surface 421. The front expanding surface 432 gradually expands the measurement flow path 32 in a direction from the flow rate sensor 22 toward the measurement outlet 36. The cross-sectional area of the measurement flow path 32 gradually increases in a direction from the front peak 111a toward a downstream end part of the front expanding surface 432. The front expanding surface 432 is arched such that a portion of the front expanding surface 432 between an upstream end part and the downstream end part of the front expanding surface 432 bulges toward the center line CL4 of the measurement flow path 32.

The front narrowing upstream surface 433 extends straight from the upstream end part of the front narrowing surface 431 toward the measurement inlet 35 parallel to the arrangement line CL31. The front narrowing upstream surface 433 is provided between the upstream outer curved surface 411 and the front narrowing surface 431 in the upstream curved path 406. The front narrowing upstream surface 433 connects the upstream outer curved surface 411 and the front narrowing surface 431. The front expanding downstream surface 434 extends straight from the downstream end part of the front expanding surface 432 toward the measurement outlet 36 parallel to the arrangement line CL31. The front expanding downstream surface 434 is provided between the downstream outer curved surface 421 and the front expanding surface 432 in the downstream curved path 407. The front expanding downstream surface 434 connects the downstream outer curved surface 421 and the front expanding surface 432. The front narrowing upstream surface 433 and the front expanding downstream surface 434 are arranged in the depth direction Z and are coplanar with each other because the positions in the width direction X are overlapped.

The back measurement wall surface 104 includes a back narrowing surface 441, a back expanding surface 442, a back narrowing upstream surface 443, and a back expanding downstream surface 444. The back narrowing surface 441 and the back expanding surface 442 are formed by the back narrowed portion 112 and are included in an outer surface of the back narrowed portion 112. That is, the back narrowed portion 112 includes the back narrowing surface 441 and the back expanding surface 442. In the back narrowed portion 112, the back narrowing surface 441 extends in the depth direction Z from the back peak 112a toward the upstream curved path 406 while the back expanding surface 442 extends in the depth direction Z from the back peak 112a toward the downstream curved path 407. The back peak 112a is a boundary between the back narrowing surface 441 and the back expanding surface 442.

The back narrowing surface 441 is inclined with respect to the center line CL4 of the measurement flow path 32 in the detection measurement path 353. The back narrowing surface 441 faces toward the upstream outer curved surface 411. The back narrowing surface 441 gradually reduces and narrows the measurement flow path 32 in a direction from the measurement inlet 35 toward the flow rate sensor 22. The cross-sectional area of the measurement flow path 32 gradually decreases in a direction from an upstream end part of the back narrowing surface 441 toward the back peak 112a. The back narrowing surface 441 is arched such that a portion of the back narrowing surface 441 between the upstream end part and a downstream end part of the front narrowing surface 431 bulges toward the center line CL4 of the measurement flow path 32.

The back expanding surface 442 is inclined with respect to the center line CL4 of the measurement flow path 32 in the detection measurement path 353. The back expanding surface 442 faces toward the downstream outer curved surface 421. The back expanding surface 442 gradually expands the measurement flow path 32 in a direction from the flow rate sensor 22 toward the measurement outlet 36. The cross-sectional area of the measurement flow path 32 gradually increases in a direction from the back peak 112a toward a downstream end part of the back expanding surface 442. The back expanding surface 442 is arched such that a portion of the back expanding surface 442 between an upstream end part and the downstream end part of the back expanding surface 442 bulges toward the center line CL4 of the measurement flow path 32.

The back narrowing upstream surface 443 extends straight from the upstream end part of the back narrowing surface 441 toward the measurement inlet 35 parallel to the arrangement line CL31. The back narrowing upstream surface 443 is provided between the upstream outer curved surface 411 and the back narrowing surface 441 in the upstream curved path 406. The back narrowing upstream surface 443 connects the upstream outer curved surface 411 and the back narrowing surface 441. The back expanding downstream surface 444 extends straight from the downstream end part of the back expanding surface 442 toward the measurement outlet 36 parallel to the arrangement line CL31. The back expanding downstream surface 444 is provided between the downstream outer curved surface 421 and the back expanding surface 442 in the downstream curved path 407. The back expanding downstream surface 444 connects the downstream outer curved surface 421 and the back expanding surface 442. The back narrowing upstream surface 443 and the back expanding downstream surface 444 are arranged in the depth direction Z and are coplanar with each other because the positions in the width direction X are overlapped.

The narrowed portions 111, 112 correspond to a measurement narrowed portion. The front narrowing surface 431 and the back narrowing surface 441 correspond to a measurement narrowing surface. The front expanding surface 432 and the back expanding surface 442 correspond to a measurement expanding surface. As described above, the center CO1 of the heating resistor 71, the front peak 111a, and the back peak 112a are aligned in the width direction X. The front peak 111a and the back peak 112a are located on the center line CL5 of the heating resistor 71.

In the depth direction Z in which the arrangement line CL31 extends, a length W31a of the front narrowed portion 111 and a length W31b of the back narrowed portion 112 are the same. In the front narrowed portion 111, a length W32a of the front narrowing surface 431 in the depth direction Z is smaller than a length W33a of the front expanding surface 432 in the depth direction Z. That is, there is a relationship of W32a<W33a. In the back narrowed portion 112, a length W32b of the back narrowing surface 441 in the depth direction Z is smaller than a length W33b of the back expanding surface 442 in the depth direction Z. That is, there is a relationship of W32b<W33b. In the narrowed portions 111, 112, the length W32a of the front narrowing surface 431 and the length W32b of the back narrowing surface 441 are the same, and the length W33a of the front expanding surface 432 and the length W33b of the back expanding surface 442 are the same.

The front narrowed portion 111 is provided at a position relatively near the upstream curved path 406 in the depth direction Z. In this case, on the arrangement line CL31, a distance W34a between the front narrowed portion 111 and the upstream outer curved surface 411 is larger than a distance W35a between the front narrowed portion 111 and the downstream outer curved surface 421. That is, there is a relationship of W34a>W35a. The back narrowed portion 112 is, similar to the front narrowed portion 111, provided at a position relatively near the upstream curved path 406 in the depth direction Z. In this case, on the arrangement line CL31, a distance W34b between the back narrowed portion 112 and the upstream outer curved surface 411 is larger than a distance W35b between the back narrowed portion 112 and the downstream outer curved surface 421. That is, there is a relationship of W34b>W35b.

Regarding the positional relationship between the upstream outer curved surface 411 and the narrowed portions 111, 112, the distance W34a and the distance W34b are the same. Regarding the positional relationship between the downstream outer curved surface 421 and the narrowed portions 111, 112, the distance W35a and the distance W35b are the same.

In the measurement flow path 32, the measurement width dimension W1 (see FIG. 16) between the front measurement wall surface 103 and the back measurement wall surface 104 varies depending on the position. This measurement width dimension W1 is different in the sensor path 405, the upstream curved path 406, and the downstream curved path 407. The measurement width dimension W1 is not uniform in each of the sensor path 405, the upstream curved path 406, and the downstream curved path 407. However, a distance D34 between the front narrowing upstream surface 433 and the back narrowing upstream surface 443 in the upstream curved path 406 is the same as a distance D38 between the front expanding downstream surface 434 and the back expanding downstream surface 444 in the downstream curved path 407.

The sensor support 51 is provided in the upstream curved path 406 at a central position between the front narrowing upstream surface 433 and the back narrowing upstream surface 443. Here, a center line CL32 of the sensor SA50 is defined. The center line CL32 is a straight imaginary line that passes through the center of the sensor support 51 in the width direction X on the center line CL5 of the heating resistor 71. The center line CL32 is orthogonal to the center line CL5 and extends in the depth direction Z. The center line CL32 is parallel to the arrangement line CL31. In this case, in the upstream curved path 406, a distance D31a between the center line CL32 and the front narrowing upstream surface 433 is the same as a distance D31b between the center line CL32 and the back narrowing upstream surface 443.

The sensor support 51 is provided in the downstream curved path 407 at a central position between the front expanding downstream surface 434 and the back expanding downstream surface 444. In the downstream curved path 407, a distance D35a between the center line CL32 and the front expanding downstream surface 434 is the same as a distance D35b between the center line CL32 and the back expanding downstream surface 444. Regarding the positional relationship between the front measurement wall surface 103 and the sensor support 51, the distance D31a and the distance D35a are the same. Regarding the positional relationship between the back measurement wall surface 104 and the sensor support 51, the distance D31b and the distance D35b are the same.

Since front narrowing upstream surface 433 and the front expanding downstream surface 434 are coplanar with each other in the front measurement wall surface 103, a protrusion height of the front narrowed portion 111 in the upstream curved path 406 and a protrusion height of the front narrowed portion 111 in the downstream curved path 407 are the same. Specifically, a protrusion height D32a of the front peak 111a with respect to the front narrowing upstream surface 433 and a protrusion height D36a of the front peak 111a with respect to the front expanding downstream surface 434 are the same.

A protrusion height of the front narrowing surface 431 with respect to the front narrowing upstream surface 433 gradually increases in a direction from the front narrowing upstream surface 433 toward the front peak 111a. This increase rate gradually decreases in the direction from the front narrowing upstream surface 433 toward the front peak 111a. Hence, the front narrowing surface 431 is an arched surface. A protrusion height of the front expanding surface 432 with respect to the front expanding downstream surface 434 gradually decreases in a direction from the front peak 111a toward the front expanding downstream surface 434. This decrease rate gradually increases in the direction from the front peak 111a toward the front expanding downstream surface 434. Hence, the front expanding surface 432 is an arched surface.

As described above, in the front narrowed portion 111, the length W33a of the front expanding surface 432 is larger than the length W32a of the front narrowing surface 431. In this case, the decrease rate of the protrusion height of the front expanding surface 432 from the front peak 111a to the front expanding downstream surface 434 is smaller than the increase rate of the protrusion height of the front narrowing surface 431 from the front narrowing upstream surface 433 to the front peak 111a. The front narrowing surface 431 and the front expanding surface 432 form a continuous arched surface. A tangent line of the front narrowing surface 431 at the front peak 111a and a tangent line of the front expanding surface 432 at the front peak 111a are both parallel to the arrangement line CL31.

Since back narrowing upstream surface 443 and the back expanding downstream surface 444 are coplanar with each other in the back measurement wall surface 104, a protrusion height of the back narrowed portion 112 in the upstream curved path 406 and a protrusion height of the back narrowed portion 112 in the downstream curved path 407 are the same. Specifically, a protrusion height D32b of the back peak 112a with respect to the back narrowing upstream surface 443 and a protrusion height D36b of the back peak 112a with respect to the back expanding downstream surface 444 are the same.

A protrusion height of the back narrowing surface 441 with respect to the back narrowing upstream surface 443 gradually increases in a direction from the back narrowing upstream surface 443 toward the back peak 112a. This increase rate gradually decreases in the direction from the back narrowing upstream surface 443 toward the back peak 112a. Hence, the back narrowing surface 441 is an arched surface. A protrusion height of the back expanding surface 442 with respect to the back expanding downstream surface 444 gradually decreases in a direction from the back peak 112a toward the back expanding downstream surface 444. This decrease rate gradually increases in the direction from the back peak 112a toward the back expanding downstream surface 444. Hence, the back expanding surface 442 is an arched surface.

As described above, in the back narrowed portion 112, the length W33b of the back expanding surface 442 is larger than the length W32b of the back narrowing surface 441. In this case, the decrease rate of the protrusion height of the back expanding surface 442 from the back peak 112a to the back expanding downstream surface 444 is smaller than the increase rate of the protrusion height of the back narrowing surface 441 from the back narrowing upstream surface 443 to the back peak 112a. The back narrowing surface 441 and the back expanding surface 442 form a continuous arched surface. A tangent line of the back narrowing surface 441 at the back peak 112a and a tangent line of the back expanding surface 442 at the back peak 112a are both parallel to the arrangement line CL31.

The sensor support 51 is disposed at a center position between the front measurement wall surface 103 and the back measurement wall surface 104 in the upstream curved path 406 and the downstream curved path 407. However, the sensor support 51 is located relatively near the front measurement wall surface 103 in the sensor path 405. This is because the protrusion height of the front narrowed portion 111 on the front measurement wall surface 103 is larger than the protrusion height of the back narrowed portion 112 on the back measurement wall surface 104. Specifically, the protrusion heights D32a, D36a of the front peak 111a with respect to the front narrowing upstream surface 433 and the front expanding downstream surface 434 are larger than the protrusion heights D32b, D36b of the back peak 112a with respect to the back narrowing upstream surface 443 and the back expanding downstream surface 444. As a result, a distance D33a between the center line CL32 of the sensor support 51 and the front peak 111a is smaller than a distance D33b between the center line CL32 and the back peak 112a.

The housing 21 includes a measurement partition 451. The measurement partition 451 is provided between the introduction measurement path 352 and the discharge measurement path 354 in the depth direction Z. The measurement partition 451 partitions the introduction measurement path 352 and the discharge measurement path 354. In addition, the measurement partition 451 is provided between the through flow path 31 or a branch measurement path 351 and the detection measurement path 353 in the height direction Y. The measurement partition 451 partitions the through flow path 31 or the branch measurement path 351 and the detection measurement path 353. The measurement partition 451 connects the front measurement wall surface 103 and the back measurement wall surface 104 in the width direction X. The measurement partition 451 forms the inner measurement curved surface 402. An outer surface of the measurement partition 451 includes the measurement floor surface 101, the upstream inner curved surface 415, and the inner measurement curved surface 402 such as the downstream inner curved surface 425.

The narrowed portions 111, 112 extend from the measurement partition 451 toward the measurement ceiling surface 102. The narrowed portions 111, 112 do not extend out of the measurement partition 451 in the depth direction Z toward either the upstream outer curved surface 411 or the downstream outer curved surface 421. In the depth direction Z, a width of the measurement partition 451 is equal to or larger than the lengths W31a, W31b of the narrowed portions 111, 112. The narrowed portions 111, 112 are provided between the upstream curved path 406 and the downstream curved path 407. In the present embodiment, the upstream end parts of the narrowed portions 111, 112 are provided in the upstream curved path 406. The downstream end parts of the narrowed portions 111, 112 are provided in the downstream curved path 407. Even in this configuration, the narrowed portions 111, 112 are provided between the upstream curved path 406 and the downstream curved path 407.

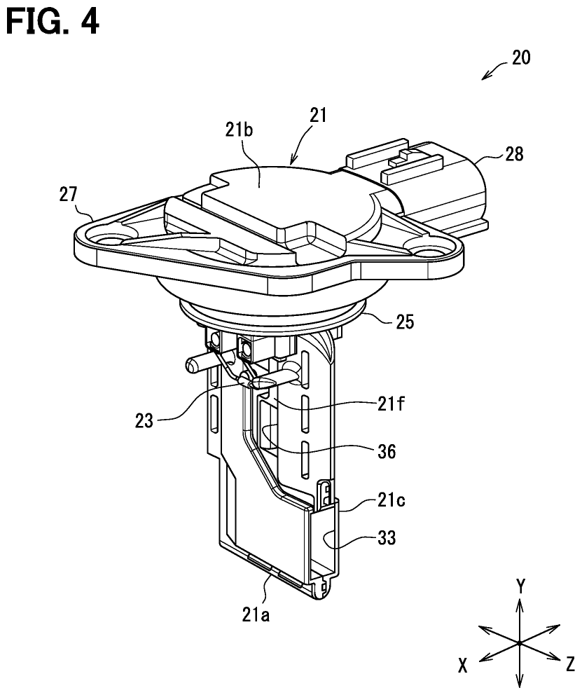

As shown in FIGS. 4 to 7, the through inlet 33 is provided on the housing upstream surface 21c, and is open toward an upstream side in the intake passage 12. Therefore, the main flow in the intake passage 12 in the main flow direction is likely to enter the through inlet 33. The through outlet 34 is provided on the housing downstream surface 21d, and is open toward a downstream side in the intake passage 12. Therefore, the air flowing out of the through outlet 34 is likely to flow downstream together with the main flow in the intake passage 12.

The measurement outlet 36 is provided on both the housing front surface 21e and the housing back surface 21f. The housing front surface 21e and the housing back surface 21f extend along the arrangement line CL31. The measurement outlet 36 is open in a direction orthogonal to the arrangement line CL31. Therefore, the main flow in the intake passage 12 in the main flow direction is less likely to enter the measurement outlet 36. The air flowing out of the measurement outlet 36 is likely to flow downstream together with the main flow in the intake passage 12. When the main flow passes near the measurement outlet 36 in the intake passage 12, the air immediately before the measurement outlet 36 in the measurement flow path 32 is pulled by the main flow, and therefore the air is likely to flow out of the measurement outlet 36. As a result, the air in the measurement flow path 32 easily flows out of the measurement outlet 36. The width direction X corresponds to the direction orthogonal to the arrangement line CL31. Next, a flow mode of air flowing through the measurement flow path 32 will be described.

As shown in FIG. 15, the air flowing from the through flow path 31 into the measurement flow path 32 through the measurement inlet 35 includes an outer curving flow AF31 along the outer measurement curved surface 401 and an inner curving flow AF32 along the inner measurement curved surface 402. As described above, in the measurement flow path 32, the outer measurement curved surface 401 is concavely curved as a whole. Thus, the outer curving flow AF31 is likely to be along the outer measurement curved surface 401. The inner measurement curved surface 402 is convexly curved as a whole. Thus, the inner curving flow AF32 is likely to be along the inner measurement curved surface 402. Further, the outer measurement curved surface 401 and the inner measurement curved surface 402 are curved in a direction orthogonal to the width direction X. The narrowed portions 111, 112 narrow the measurement flow path 32 in the width direction X. Therefore, in the measurement flow path 32, airflow turbulence that causes mixing of the outer curving flow AF31 and the inner curving flow AF32 is less likely to occur.

The outer curving flow AF31 that has reached the upstream curved path 406 in the measurement flow path 32 changes its flow direction by flowing along the upstream outer curved surface 411. Since the upstream outer curved surface 411 is curved more gently than the downstream outer curved surface 421, the curve of the upstream outer curved surface 411 is sufficiently mild. Hence, turbulence flow such as swirling flow is less likely to occur in the outer curving flow AF31.

As shown in FIG. 17, an airflow through the measurement flow path 32 includes a front offset flow AF33 between the sensor support 51 and the front narrowing surface 431, and a back offset flow AF34 between the sensor support 51 and the back narrowing surface 441. Air of the curving flows AF31, AF32 that has flowed along the front measurement wall surface 103 and reached the narrowed portions 111, 112 is likely to be included in the front offset flow AF33. Air of the curving flows AF31, AF32 that has flowed along the back measurement wall surface 104 and reached the narrowed portions 111, 112 is likely to be included in the back offset flow AF34.

With respect to the front side of the sensor support 51, a degree of airflow narrowing by the front narrowing surface 431 gradually increases in a direction toward the front peak 111a, and accordingly, an effect of regulating the front offset flow AF33 gradually increases in the direction toward the front peak 111a. Moreover, since the protrusion heights D32a, D36a of the front peak 111a are larger than the protrusion heights D32b, D36b of the back peak 112a, the flow regulating effect of the front narrowing surface 431 is sufficiently enhanced. As a result, the front offset flow AF33 which has been sufficiently regulated by the front narrowing surface 431 and the sensor support 51 reaches the flow rate sensor 22. Therefore, a flow rate detection accuracy of the flow rate sensor 22 is likely to be high.

The front offset flow AF33 is gradually accelerated toward the front peak 111a. Then, the front offset flow AF33 is jet out of between the front peak 111a and the sensor support 51 as a jet flow toward the downstream curved path 407. This is because an area between the front narrowed portion 111 and the sensor support 51 is expanded by the front expanding surface 432. If the area between the front expanding surface 432 and the sensor support 51 is sharply expanded, there is a concern that a turbulence such as a vortex is likely to occur due to separation of the front offset flow AF33 from the front expanding surface 432. However, since the length W33a of the front expanding surface 432 is larger than the length W32a of the front narrowing surface 431, the area between the front expanding surface 432 and the sensor support 51 is gently expanded. Therefore, separation of the front offset flow AF33 from the front expanding surface 432 is unlikely to occur, and a turbulence such as vortex flow is less likely to occur downstream of the front peak 111a.

With respect to the back side of the sensor support 51, a degree of airflow narrowing by the back narrowing surface 441 gradually increases in a direction toward the back peak 112a, and accordingly, an effect of regulating the back offset flow AF34 gradually increases in the direction toward the back peak 112a. In this case, the back offset flow AF34 which has been sufficiently regulated by the back narrowing surface 441 and the sensor support 51 reaches the back peak 112a. Therefore, a turbulence is unlikely to occur in the back offset flow AF34 even after passing through the back peak 112a.

The back offset flow AF34 is gradually accelerated toward the back peak 112a. Then, the back offset flow AF34 is jet out of between the back peak 112a and the sensor support 51 as a jet flow toward the downstream curved path 407. This is because an area between the back narrowed portion 112 and the sensor support 51 is expanded by the back expanding surface 442. If the area between the back expanding surface 442 and the sensor support 51 is sharply expanded, there is a concern that a turbulence such as a vortex is likely to occur due to separation of the back offset flow AF34 from the back expanding surface 442. However, since the length W33b of the back expanding surface 442 is larger than the length W32b of the back narrowing surface 441, the area between the back expanding surface 442 and the sensor support 51 is gently expanded. Therefore, separation of the back offset flow AF34 from the back expanding surface 442 is unlikely to occur, and a turbulence such as vortex flow is less likely to occur downstream of the back peak 112a.

The front offset flow AF33 and the back offset flow AF34 are expected to join together in the sensor path 405 and the downstream curved path 407 after passing by the sensor support 51. For example, if the back offset flow AF34 has turbulence, turbulence of air flow may be generated downstream of the sensor support 51, and the front offset flow AF33 is difficult to pass between the front narrowed portion 111 and the sensor support 51. In this case, there is a concern that a flow rate and a flow velocity of the front offset flow AF33 passing through the flow rate sensor 22 become insufficient, and the flow rate detection accuracy of the flow rate sensor 22 may decrease. In contrast, in the present embodiment, the back offset flow AF34 is regulated by the back narrowed portion 112. Thus, generation of turbulence downstream of the sensor support 51 caused by turbulence of the back offset flow AF34 flowing past the sensor support 51 can be reduced.

When the front offset flow AF33 and the back offset flow AF34 are discharged from between the sensor support 51 and the narrowed portions 111, 112 toward the downstream curved path 407, these offset flows AF33, AF34 proceed as a forward flow toward the downstream outer curved surface 421 along the arrangement line CL31. When the offset flows AF33, AF34 hit the downstream outer curved surface 421, the offset flows AF33, AF34 may bounce back from downstream outer curved surface 421 and flow backward in the measurement flow path 32 in a direction toward the flow rate sensor 22. In particular, when hitting the downstream outer vertical surface 423, the offset flows AF33, AF34 are likely to flow backward to the flow rate sensor 22 along the arrangement line CL31. If the backward flow reaches the flow rate sensor 22 against the forward flow, the direction of air flow detected by the flow rate sensor 22 may become opposite to the original flow, and the detection accuracy of the flow rate sensor 22 may decrease. Further, even if the backward flow does not reach the flow rate sensor 22, the backward flow causes the forward flow to become difficult to flow downstream. Therefore, the flow rate detected by the flow rate sensor 22 may become smaller than the actual flow rate, and the detection accuracy of the flow rate sensor 22 may decrease.

In contrast, in the present embodiment, the flow rate sensor 22 is provided at a position nearer to the upstream outer curved surface 411 than to the downstream outer curved surface 421. Thus, the flow rate sensor 22 is at a position separated as much as possible from the downstream outer curved surface 421. According to this configuration, the velocity energy of the offset flows AF33, AF34 is likely to decrease before the offset flows AF33, AF34 blown out between the sensor support 51 and the narrowed portions 111, 112 reach the downstream outer curved surface 421. Hence, even if the offset flows AF33, AF34 bounce back from the downstream outer curved surface 421 and become the backward flow, the velocity energy of the backward flow is too low to reach the flow rate sensor 22. Further, the farther the flow rate sensor 22 is from the downstream outer curved surface 421, the longer the distance for the backward flow to reach the flow rate sensor 22. Thus, the backward flow can be suppressed from reaching the flow rate sensor 22.

The imaginary line passing through the flow rate sensor 22 is defined as the arrangement line CL31. Thus, air of the front offset flow AF33 that has passed through the flow rate sensor 22 is likely to flow along the arrangement line CL31. Therefore, maximum enlargement in distance L31b between the flow rate sensor 22 and the downstream outer curved surface 421 on the arrangement line CL31 can maximizes a distance for the air of the front offset flow AF33 passing through the flow rate sensor 22 to reach the downstream outer curved surface 421. The arrangement line CL31 passes through the downstream outer vertical surface 423 in the present embodiment. In this configuration, when the air that has passed through the flow rate sensor 22 hits the downstream outer vertical surface 423 and bounces back, the air is likely to return to the flow rate sensor 22 as it is. In such configuration in which the arrangement line CL31 passes through the downstream outer vertical surface 423, the maximum enlargement in distance L31b between the flow rate sensor 22 and the downstream outer curved surface 421 on the arrangement line CL31 is effective for suppressing of the backward flow from reaching the flow rate sensor 22.

According to the present embodiment as described above, on the arrangement line CL31, the distance L31b between the flow rate sensor 22 and the downstream outer curved surface 421 is larger than the distance L31a between the flow rate sensor 22 and the upstream outer curved surface 411. In this configuration, the flow rate sensor 22 can be placed at a position as far as possible from the downstream outer curved surface 421 between the upstream outer curved surface 411 and the downstream outer curved surface 421. Therefore, even if the air that has passed through the flow rate sensor 22 in the measurement flow path 32 hits the downstream outer curved surface 421 and flows backward in the direction toward the flow rate sensor 22, the backward flow is difficult to reach the flow rate sensor 22. Further, even if a turbulence of air flow due to the backward flow occurs in the downstream curved path 407, this turbulence hardly reach the flow rate sensor 22. Therefore, decrease in detection accuracy of the flow rate sensor 22 can be reduced. As a result, an accuracy in measurement of the flow rate by the air flow meter 20 can be enhanced.

In order to maximize the distance L31b between the flow rate sensor 22 and the downstream outer curved surface 421, the downstream outer curved surface 421 may be separated from the flow rate sensor 22 by extending the detection measurement path 353 in the depth direction Z, for example. However, in this method, there is a concern that the housing 21 may become large in the depth direction Z. In this case, air flow in the intake passage 12 may be disturbed by the housing 21, and the detection accuracy of the flow rate sensor 22 is likely to decrease. Further, in this case, a necessary amount of resin material for molding the housing 21 increases, and thus a manufacturing cost of the housing 21 tends to increase.

In contrast, in the present embodiment, the distance L31b between the flow rate sensor 22 and the downstream outer curved surface 421 is maximized by setting the flow rate sensor 22 at a position near the upstream outer curved surface 411 in the detection measurement path 353. Accordingly, the housing 21 can be prevented from becoming large. In this case, air flow in the intake passage 12 may not be disturbed by the housing 21, and the detection accuracy of the flow rate sensor 22 can be enhanced. Further, in this case, a necessary amount of resin material for molding the housing 21 tends to decrease, and thus a manufacturing cost of the housing 21 can be reduced.

According to the present embodiment, the sensor path 405 in which the flow rate sensor 22 is disposed extends along the arrangement line CL31. In this configuration, air flowing along the flow rate sensor 22 is likely to travel straight along the arrangement line CL31. Thus, turbulence of air flow is less likely to occur around the flow rate sensor 22. In this case, a flow velocity of the air around the flow rate sensor 22 is likely to be stabilized. Thus, the detection accuracy of the flow rate sensor 22 can be improved. Moreover, the flow rate sensor 22 is arranged at a position as far as possible from the downstream outer curved surface 421. Hence, the turbulence of air flow in the downstream curved path 407 is less likely to affect the flow rate sensor 22. As a result, turbulence of air flow around the flow rate sensor 22 can be suppressed. In this case, a flow velocity of the air around the flow rate sensor 22 can be further stabilized. Thus, the detection accuracy of the flow rate sensor 22 can be more improved.

According to the present embodiment, in the sensor path 405 extending along the arrangement line CL31, the flow rate sensor 22 is provided at a position closer to the upstream curved path 406 than to the downstream curved path 407. In this configuration, in the sensor path 405, turbulence of air around the flow rate sensor 22 can be suppressed and the flow velocity of the air can be stabilized. And further, the flow rate sensor 22 can be arranged at a position as far as possible from the downstream outer curved surface 421.

According to the present embodiment, on the arrangement line CL31, the sensor support 51 is provided at a position closer to the upstream outer curved surface 411 than to the downstream curved path 407. In this configuration, the sensor support 51 can be arranged at a position as far as possible from the downstream curved path 407. Hence, turbulence of air flowing into the downstream curved path 407 due to the presence of the sensor support 51 can be reduced.

According to the present embodiment, the arrangement line CL31 passes through the downstream outer vertical surface 423 of the downstream outer curved surface 421. In this configuration, the downstream outer vertical surface 423 extends straight to upstream from a downstream end part of the downstream curved path 407. Hence, the arrangement line CL31 passes through a farthest part of the downstream outer curved surface 421 from the flow rate sensor 22. In this way, the distance for the air passing through the flow rate sensor 22 to reach the downstream outer curved surface 421 is enlarged as large as possible. As a result, it can be reduced that the air passing through the flow rate sensor 22 bounces at the downstream outer curved surface 421 and flows back to the flow rate sensor 22 as backward flow.

According to the present embodiment, since the downstream inner curved surface 425 is arched, the distance L35b between the downstream outer curved surface 421 and the downstream inner curved surface 425 in the downstream curved path 407 can be increased as much as possible. In this configuration, the downstream inner curved surface 425 is arched, and thus the cross-sectional area of the downstream curved path 407 is increased as much as possible. The volume of the downstream curved path 407 is maximized. Therefore, even if turbulence of air flow occurs in the downstream curved path 407 due to air bounce on the downstream outer curved surface 421, the air in the downstream curved path 407 easily flows toward the measurement outlet 36 together with this turbulence. Therefore, it can be more certainly reduced that the backward flow reaches the flow rate sensor 22 from the downstream curved path 407.

According to the present embodiment, the narrowed portions 111, 112 that gradually narrow and then gradually expand the measurement flow path 32 are provided between the upstream end part of the upstream curved path 406 and the downstream end part of the downstream curved path 407. In this configuration, the air that has passed through the narrowed portions 111, 112 is blown out as a jet flow toward the downstream curved path 407 at high velocity. Thus there is a concern that the air is likely to bounce on the downstream outer curved surface 421.

Therefore, such arrangement of the flow rate sensor 22 at a position as far as possible from the downstream outer curved surface 421 is effective to prevent the air bounded at the downstream outer curved surface 421 from reaching the flow rate sensor 22.

According to the present embodiment, in the narrowed portions 111, 112, the lengths W33a, W33b of the expanding surfaces 432, 442 are larger than the length W32a, W32b of the narrowing surfaces 431, 441. In this configuration, a degree of expansion and an expansion rate of the expanding surfaces 432, 442 in the measurement flow path 32 are moderated so as to prevent turbulence such as separation of air flow caused by sharp expansion in the measurement flow path 32. As a result, turbulence of flow in the downstream curved path 407 caused by air which has passed through the narrowed portions 111, 112 can be reduced.

According to the present embodiment, the narrowed portions 111, 112 are provided at a position closer to the upstream outer curved surface 411 than to the downstream outer curved surface 421. In this configuration, the narrowed portions 111, 112 can be placed at a position as far as possible from the downstream outer curved surface 421 between the upstream outer curved surface 411 and the downstream outer curved surface 421. Therefore, the velocity energy of the air which has passed through the narrowed portions 111, 112 at the time of hitting the downstream outer curved surface 421 can be reduced without enlarging the housing 21.

According to the present embodiment, the front measurement wall surface 103 and the back measurement wall surface 104 face each other through the upstream curved path 406. The measurement wall surfaces 103, 104 are provided with the narrowed portions 111, 112. In this configuration, a direction in which the air curves in the upstream curved path 406 and a direction in which the air is narrowed by the narrowed portions 111, 112 are substantially orthogonal to each other. Therefore, when an airflow such as the outer curving flow AF31 along the upstream outer curved surface 411 and an airflow such as the inner curving flow AF32 along the upstream inner curved surface 415 pass through the narrowed portions 111, 112, turbulence caused by mixing of the airflows can be reduced. Therefore, an effect of regulating airflow by the narrowed portions 111, 112 can be enhanced.

According to the present embodiment, the upstream outer curved surface 411 is arched. In this configuration, a direction of airflow such as the outer curving flow AF31 along the outer measurement curved surface 401 is gradually changed by the upstream outer curved surface 411. Thus, turbulence is less likely to be generated in the airflow along the upstream outer curved surface 411. Therefore, turbulence is less likely to be generated in air flow that reaches the flow rate sensor 22 such as the outer curving flow AF31. Turbulence is less likely to be generated also in air blown toward the downstream curved path 407.

According to the present embodiment, the inner measurement curved surface 402 extending along the measurement flow path 32 is curved so as to bulge toward the flow rate sensor 22 as a whole. In this configuration, a concave portion is not formed on the inner measurement curved surface 402. Thus, air flow such as the inner curving flow AF32 along the inner measurement curved surface 402 is prevented from entering the concave portion and is less likely to cause turbulence such as vortex. Therefore, turbulence is less likely to be generated in air flow that reaches the flow rate sensor 22 such as the inner curving flow AF32. Turbulence is less likely to be generated also in air blown toward the downstream curved path 407.

According to the present embodiment, the measurement outlets 36 are provided on the housing front surface 21e and the housing back surface 21f of the outer surface of the housing 21. In this configuration, when air flows along the measurement outlets 36 of the housing front surface 21e and the housing back surface 21f in the intake passage 12, this air pulls out air in the measurement flow path 32 to flow out of the measurement outlet 36. Therefore, even if turbulence of air flow occurs in the downstream curved path 407 due to bounce of air or the like, the air flowing outside the housing 21 in the intake passage 12 is used to accelerate an air flow together with the turbulence of air flow from the downstream curved path 407 toward the measurement outlet 36.

According to the present embodiment, in the sensor SA 50, the molded front surface 55e and the molded back surface 55f are both formed by the resin molded portion 55. In this configuration, smoothness of the molded front surface 55e and the molded back surface 55f can be easily managed. Thus, separation or turbulence is less likely to be generated in air flowing along the molded front surface 55e and the molded back surface 55f.

### Second Embodiment

In the first embodiment, the downstream outer curved surface 421 includes the downstream outer internal corner 424, but in the second embodiment, the downstream outer curved surface 421 includes an arched portion. In the present embodiment, components denoted by the same reference numerals as those in the drawings according to the first embodiment and the configurations not described are the same as those in the first embodiment, and have the same operation and effects. In the present embodiment, differences from the first embodiment will be mainly described.

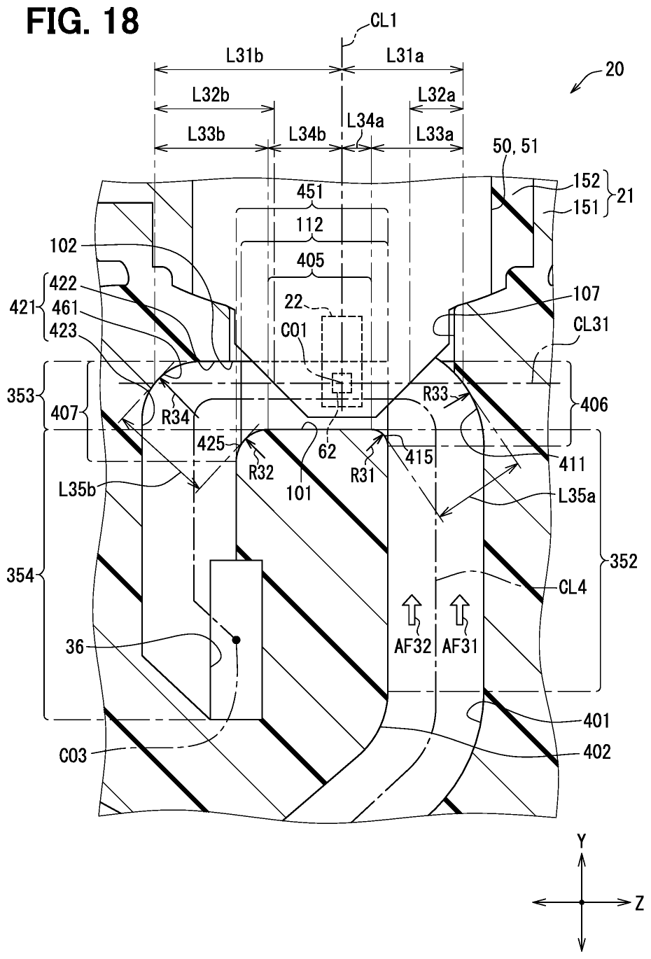

As shown in FIG. 18, the downstream outer curved surface 421 includes a downstream outer arched surface 461 in addition to the downstream outer horizontal surface 422 and the downstream outer vertical surface 423. The downstream outer arched surface 461 concavely extends along the center line CL4 of the measurement flow path 32. The downstream outer arched surface 461 is arched so as to be continuously curved along the center line CL4. The downstream outer arched surface 461 is provided between the downstream outer horizontal surface 422 and the downstream outer vertical surface 423 in the direction in which the center line CL4 extends. The downstream outer arched surface 461 connects the downstream outer horizontal surface 422 and the downstream outer vertical surface 423.

A radius of curvature R34 of the downstream outer arched surface 461 is smaller than the radius of curvature R33 of the upstream outer curved surface 411. Thus, similar to the first embodiment, the curve of the downstream outer curved surface 421 is sharper than the curve of the upstream outer curved surface 411. On the other hand, the radius of curvature R34 of the downstream outer arched surface 461 is larger than the radius of curvature R32 of the downstream inner curved surface 425. Thus, the curve of the downstream outer curved surface 421 is gentler than the curve of the downstream inner curved surface 425.

The arrangement line CL31 passes through the downstream outer arched surface 461 of the downstream outer curved surface 421 without through the downstream outer vertical surface 423. In this configuration, air that has passed through the flow rate sensor 22 and traveled along the arrangement line CL31 changes its flow direction by hitting the downstream outer arched surface 461. Thus, the air is easier to travel toward the downstream side of the downstream curved path 407.

According to the present modification, the downstream outer curved surface 421 includes the downstream outer arched surface 461. Hence, the air blown out from between the sensor support 51 and the narrowed portions 111, 112 toward the downstream curved path 407 is likely to flow along the downstream outer arched surface 461. In this case, the air that has passed through the flow rate sensor 22 is less likely to stay in the downstream curved path 407. Therefore, decrease in the flow rate and flow velocity of the air passing through the flow rate sensor 22 can be reduced.

### Third Embodiment

In the first embodiment, the narrowing surfaces 431, 441 and the expanding surfaces 432, 442 are arched so as to bulge in the narrowed portions 111, 112. However, in a third embodiment, the narrowing surfaces 431, 441 and the expanding surfaces 432, 442 are not arched. In the present embodiment, components denoted by the same reference numerals as those in the drawings according to the first embodiment and the configurations not described are the same as those in the first embodiment, and have the same operation and effects. In the present embodiment, differences from the first embodiment will be mainly described.

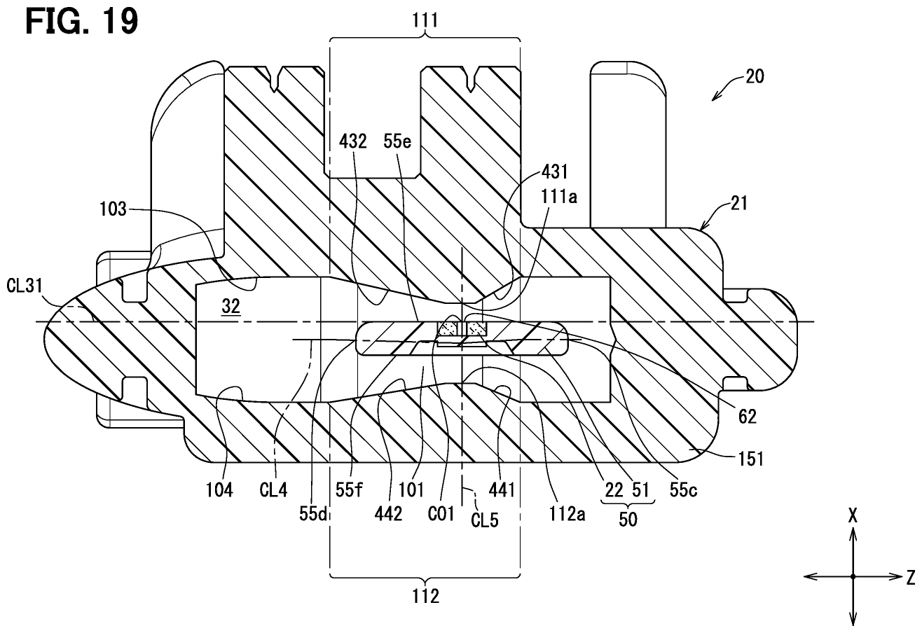

As shown in FIG. 19, in the narrowed portions 111, 112, the narrowing surfaces 431, 441 extend straight from the peaks 111a, 112a to upstream, and the expanding surfaces 432, 442 extend straight from the peaks 111a, 112a to downstream. The narrowing surfaces 431, 441 are inclined with respect to the arrangement line CL31 so as to face upstream in the measurement flow path 32. The expanding surfaces 432, 442 are inclined with respect to the arrangement line CL31 so as to face downstream in the measurement flow path 32. Increase rates of the protrusion heights of the narrowing surfaces 431, 441 are constant from the narrowing upstream surfaces 433, 443 toward the peaks 111a, 112a. Decrease rates of the protrusion heights of the expanding surfaces 432, 442 are constant from the peaks 111a, 112a toward the expanding downstream surfaces 434, 444.

The narrowed portions 111, 112 have end surfaces extending along the arrangement line CL1, and these end surfaces are the peaks 111a, 112a. The centers of the peaks 111a, 112a in the depth direction Z are at positions closer to the downstream curved path 407 than the center line CL5 of the heating resistor 71 is.

According to this modification, since the front narrowing surface 431 and the back narrowing surface 441 extend straight. Therefore, the air flow regulating effect by these narrowing surfaces 431, 441 can be improved. Further, the front expanding surface 432 and the back expanding surface 442 extend straight. Therefore, turbulence of airflow such as separation of the airflow from the expanding surfaces 432, 442 is likely to be generated without deteriorating the detection accuracy of the flow rate sensor 22. In this case, the velocity energy of the air blown out as a jet flow toward the downstream curved path 407 from between the sensor support 51 and the expanding surfaces 432, 442 can be reduced. Therefore, it can be reduced that the jet flow bounces back on the downstream outer curved surface 421 and returns to the flow rate sensor 22 as a backward flow.

Although a plurality of embodiments according to the present disclosure have been described above, the present disclosure is not construed as being limited to the above-mentioned embodiments, and can be applied to various embodiments and combinations within a scope not departing from the spirit of the present disclosure.

As a first modification, the downstream outer curved surface 421 may be a downstream outer arched surface. For example, in the second embodiment, the downstream outer curved surface 421 includes the downstream outer arched surface 461, but may not include at least one of the downstream outer horizontal surface 422 and the downstream outer vertical surface 423. For example, the downstream outer curved surface 421 does not include both the downstream outer horizontal surface 422 and the downstream outer vertical surface 423. In this configuration, the downstream outer arched surface 461 connects the upstream end part and the downstream end part of the downstream curved path 407. In this case, the downstream outer curved surface 421 is the downstream outer arched surface 461 as a whole. The downstream outer curved surface 421 corresponds to a downstream outer arched surface.

As a second modification, the upstream outer curved surface 411 may include at least one of an upstream outer vertical surface and an upstream outer horizontal surface. The upstream outer vertical surface extends straight from the upstream end part of the upstream curved path 406. The upstream outer horizontal surface extends straight from the downstream end part of the upstream curved path 406. In this configuration, the entire of the upstream outer curved surface 411 is not an upstream outer arched surface. The upstream outer curved surface 411 includes not only the at least one of the upstream outer vertical surface and the upstream outer horizontal surface but also the upstream outer arched surface. For example, in a configuration in which the upstream outer curved surface 411 includes the upstream outer vertical surface and the upstream outer arched surface, the arrangement line CL31 may pass through the upstream outer vertical surface. Further, in the upstream outer curved surface 411, an upstream outer internal corner may be formed as an internal corner in which the upstream outer vertical surface and the upstream outer horizontal surface join inwardly with each other.

As a third modification, the upstream inner curved surface 415 may include at least one of an upstream inner vertical surface and an upstream inner horizontal surface. The upstream inner vertical surface extends straight from the upstream end part of the upstream curved path 406. The upstream inner horizontal surface extends straight from the downstream end part of the upstream curved path 406. In this configuration, the entire of the upstream inner curved surface 415 is not an upstream inner arched surface. The upstream inner curved surface 415 includes not only the at least one of the upstream inner vertical surface and the upstream inner horizontal surface but also the upstream inner arched surface. Further, in the upstream inner curved surface 415, an upstream outer external corner may be formed as an external corner in which the upstream inner vertical surface and the upstream inner horizontal surface join outwardly.

As a fourth modification, the downstream inner curved surface 425 may include at least one of a downstream inner vertical surface and a downstream inner horizontal surface. The downstream inner vertical surface extends straight from the downstream end part of the downstream curved path 407. The downstream inner horizontal surface extends straight from the upstream end part of the downstream curved path 407. In this configuration, the entire of the downstream inner curved surface 425 is not a downstream inner arched surface. The downstream inner curved surface 425 includes not only the at least one of the downstream inner vertical surface and the downstream inner horizontal surface but also the downstream inner arched surface. Further, in the downstream inner curved surface 425, a downstream outer external corner may be formed as an external corner in which the downstream inner vertical surface and the downstream inner horizontal surface join outwardly.

As a fifth modification, the outer curved surfaces 411, 421 and the inner curved surfaces 415, 425 may have at least one inclined surface inclined with respect to the arrangement line CL31, and thus may be curved not continuously but stepwise. For example, the downstream outer curved surface 421 has a downstream outer inclined surface as the inclined surface that extends straight in a direction inclined with respect to the arrangement line CL31. In this configuration, a connection portion between the downstream outer horizontal surface 422 and the downstream outer vertical surface 423 is chamfered by the downstream outer inclined surface. The downstream outer curved surface 421 does not have the downstream outer internal corner 424. In addition, multiple downstream outer inclined surfaces may be arranged along the center line CL4 of the measurement flow path 32. In this configuration, the downstream outer curved surface 421 has a shape that is curved stepwise by the multiple downstream outer inclined surfaces.

As a sixth modification, the configuration in which the degree of recess of the downstream outer curved surface 421 is larger than the degree of recess of the upstream outer curved surface 411 may be realized regardless of the radius of curvature. For example, the entire of the downstream outer curved surface 421 may be the downstream outer arched surface. The entire of the upstream outer curved surface 411 may be the upstream outer arched surface. The radius of curvature R34 of the downstream outer curved surface 421 may be greater than the radius of curvature R33 of the upstream outer curved surface 411. Also in this configuration, as long as the length of the downstream outer curved surface 421 is smaller than the length of the upstream outer curved surface 411 in the direction in which the center line CL4 of the measurement flow path 32 extends, the degree of recess of the downstream outer curved surface 421 is larger than the degree of recess of the upstream outer curved surface 411.

As a seventh modification, in the sensor path 405, at least the measurement floor surface 101 only have to extend straight along the arrangement line CL31. Further, an upstream end part of the flow rate sensor 22 may be provided at the upstream end part of the sensor path 405. A downstream end part of the flow rate sensor 22 may be provided at the downstream end part of the sensor path 405. For example, the length of the sensor path 405 and the length of the flow rate sensor 22 may be the same in the depth direction Z.

As an eighth modification, in the depth direction Z, the downstream end part of the upstream outer curved surface 411 may be provided at a position closer to the flow rate sensor 22 than the downstream end part of the upstream inner curved surface 415 is. In this case, the upstream end part of the sensor path 405 is defined by the downstream end part of the upstream outer curved surface 411, not by the downstream end part of the upstream inner curved surface 415. Further, in the depth direction Z, the upstream end part of the downstream outer curved surface 421 may be provided at a position closer to the flow rate sensor 22 than the upstream end part of the downstream inner curved surface 425 is. In this case, the downstream end part of the sensor path 405 is defined by the upstream end part of the downstream outer curved surface 421, not by the upstream end part of the downstream inner curved surface 425.

As a ninth modification, the arrangement line CL31 only have to pass through the flow rate sensor 22. The arrangement line CL31 does not have to pass through the center CO1 of the heating resistor 71, for example, as long as the arrangement line CL1 passes through a part of the heating resistor 71. Further, the arrangement line CL31 may pass through the center or a part of the membrane portion 62, and may pass through the center or a part of the flow rate sensor 22. Furthermore, the arrangement line CL31 may be inclined with respect to the angle setting surface 27a of the housing 21, the depth direction Z, or the main flow direction as long as the arrangement line CL31 extends in the direction in which the upstream curved path 406 and the downstream curved path 407 are arranged.

As a tenth modification, if the flow rate sensor 22 is arranged closer to the upstream outer curved surface 411 than to the downstream outer curved surface 421 on the arrangement line CL31, the sensor support 51 does not need to be located at a position closer to the upstream outer curved surface 411 than to the downstream outer curved surface 421. In this case, in the sensor support 51, the flow rate sensor 22 is arranged at a position closer to the molded upstream surface 55c than to the molded downstream surface 55d on the arrangement line CL31.

As an eleventh modification, if the flow rate sensor 22 is arranged closer to the upstream outer curved surface 411 than to the downstream outer curved surface 421 on the arrangement line CL31, the flow rate sensor 22 does not need to be located at a position closer to the upstream end part of the sensor path 405 than to the downstream end part of the sensor path 405. In this case, on the arrangement line CL31, a distance between the upstream end part of the downstream curved path 407 and the downstream outer curved surface 421 is larger than a distance between the downstream end part of the upstream curved path 406 and the upstream outer curved surface 411.

As a twelfth modification, in the measurement flow path 32, the upstream curved path 406 and the downstream curved path 407 may be curved in opposite directions with respect to the sensor path 405. For example, both the upstream curved path 406 and the downstream curved path 407 may not extend from the sensor path 405 in the housing distal end direction. One of them may extend in the housing distal end direction, and another of them may extend in the housing basal end direction. If the upstream curved path 406 extends from the sensor path 405 in the housing distal end direction, and the downstream curved path 407 extends from the sensor path 405 in the housing basal end direction, the downstream outer curved surface 421 extends from the measurement ceiling surface 102 without extending from the measurement floor surface 101. Further, the downstream inner curved surface 425 extends from the measurement floor surface 101 without extending from the measurement ceiling surface 102.

As a thirteenth modification, only one of the measurement narrowing surface and the measurement expanding surface of the measurement narrowed portion may extend straight. For example, in the above third embodiment, at least one of the front narrowing surface 431, the front expanding surface 432, the back narrowing surface 441, and the back expanding surface 442 may extend straight. Further, the front peak 111a and the back peak 112a may be convexly arched or may be concavely arched.

As a fourteenth modification, the shapes and sizes of the narrowed portions 111, 112 may be different from the configuration of the first embodiment. For example, in the narrowed portions 111, 112, the length W32a, W32b of the narrowing surfaces 431, 441 are not need to be smaller than the lengths W33a, W33b of the expanding surfaces 432, 442. Further, the front narrowing upstream surface 433 and the front expanding downstream surface 434 may not be coplanar with each other. In this case, the protrusion height of the front narrowing surface 431 from the front narrowing upstream surface 433 is different from the protrusion height of the front expanding surface 432 from the front expanding downstream surface 434. Also in the back narrowed portion 112, as in the front narrowed portion 111, the back narrowing upstream surface 443 and the back expanding downstream surface 444 may not be coplanar with each other. In this case, the protrusion height of the back narrowing surface 441 from the back narrowing upstream surface 443 is different from the protrusion height of the back expanding surface 442 from the back expanding downstream surface 444.

As a fifteenth modification, the front narrowed portion 111 and the back narrowed portion 112 may have different shapes and sizes. For example, the length W31a of the front narrowed portion 111 may be larger or smaller than the length W31b of the back narrowed portion 112. The length W32a of the front narrowing surface 431 may be larger or smaller than the length W32b of the back narrowing surface 441. The length W33a of the front expanding surface 432 may be larger or smaller than the length W33b of the back expanding surface 442. The protrusion height D32a, D36a of the front peak 111a may be the same as or smaller than the protrusion height D32b, D36b of the back peak 112a.

As a sixteenth modification, the narrowed portions 111, 112 may extend outward of the measurement partition 451 in the depth direction Z. Further, the narrowed portions 111 and 112 may be positioned so as not enter an inside of the upstream curved path 406 or an inside of the downstream curved path 407. For example, the narrowed portions 111, 112 may be provided only in the sensor path 405 among the sensor path 405, the upstream curved path 406, and the downstream curved path 407. Further the narrowed portions 111, 112 may not be bridged by the measurement ceiling surface 102 and the measurement floor surface 101. For example, the narrowed portions 111 and 112 may extend from only one of the measurement ceiling surface 102 and the measurement floor surface 101. Further, the narrowed portions 111, 112 may be provided between the measurement ceiling surface 102 and the measurement floor surface 101 but apart from both the measurement ceiling surface 102 and the measurement floor surface 101.

As a seventeenth modification, the measurement narrowed portions such as the narrowed portions 111 and 112 only have to be provided on at least one of the front measurement wall surface 103, the back measurement wall surface 104, the outer measurement curved surface 401, and the inner measurement curved surface 402 in the measurement flow path 32. For example, at least one of the front narrowed portion 111 and the back narrowed portion 112 is provided. Further, the measurement narrowed portions may be provided to each of the measurement wall surfaces 103, 104 and the measurement curved surface 401, 402.

As an eighteenth modification, the front peak 111a and the back peak 112a in the measurement flow path 32 may not be arranged in the width direction X. For example, among the peaks 111a, 112a, only the front peak 111a may be arranged on the center line CL5 of the heating resistor 71. In this case, the back peak 112a may be arranged at a position displaced from the center line CL5 in at least one of the height direction Y and the depth direction Z.

As a nineteenth modification, the front peak 111a of the front narrowed portion 111 does not have to be arranged on the center line CL5 of the heating resistor 71. For example, the front peak 111a just have to be aligned with a part of the heating resistor 71 in the width direction X and face a part of the heating resistor 71. Further, the front peak 111a just have to be aligned with a part of the membrane portion 62 in the width direction X and face a part of the membrane portion 62. Furthermore, the front peak 111a just have to be aligned with a part of the flow rate sensor 22 in the width direction X and face a part of the flow rate sensor 22.

As a twentieth modification, the degree of recess of the downstream outer curved surface 421 does not have to be larger than the degree of recess of the upstream outer curved surface 411.

As a twenty-first modification, a physical quantity sensor for detecting a physical quantity different from the flow rate of the intake air may be provided in the measurement flow path. Examples of the physical quantity sensor provided in the measurement flow path include a detection unit for detecting a temperature, a detection unit for detecting a humidity, a detection unit for detecting a pressure, and the like in addition to the flow rate sensor 22. Those detection units may be mounted on the sensor SA 50 as the detection unit or may be provided as components separated from the sensor SA 50.

As a twenty-second modification, the air flow meter 20 does not need to include the through flow path 31. That is, the bypass flow path 30 may not be branched. For example, the measurement inlet 35 of the measurement flow path 32 may be provided on the outer surface of the housing 21. In this configuration, all of the air that has flowed into the housing 21 from the measurement inlet 35 flows out from the measurement outlet 36.

While the present disclosure has been described with reference to embodiments thereof, it is to be understood that the disclosure is not limited to the embodiments and constructions. To the contrary, the present disclosure is intended to cover various modification and equivalent arrangements. In addition, while the various elements are shown in various combinations and configurations, which are exemplary, other combinations and configurations, including more, less or only a single element, are also within the spirit and scope of the present disclosure.

1. A physical quantity measurement device measuring a physical quantity of a fluid, the physical quantity measurement device comprising:
a measurement flow path including a measurement inlet through which the fluid flows into the measurement flow path, and a measurement outlet through which the fluid that has flowed in from the measurement inlet flows out of the measurement flow path;
a physical quantity sensor that is provided in the measurement flow path and detects the physical quantity of the fluid; and
a housing that defines the measurement flow path, wherein
the measurement flow path includes:
a sensor path in which the physical quantity sensor is disposed;
an upstream curved path provided between the sensor path and the measurement inlet in the measurement flow path, the upstream curved path being curved in the housing so as to extend from the sensor path toward the measurement inlet; and
a downstream curved path provided between the sensor path and the measurement outlet in the measurement flow path, the downstream curved path being curved in the housing so as to extend from the sensor path toward the measurement outlet,
an inner surface of the housing includes:
an upstream outer curved surface that defines an outer outline of a curved part of the upstream curved path; and
a downstream outer curved surface that defines an outer outline of a curve part of the downstream curved path,
an arrangement line is defined as an imaginary straight line that passes through the physical quantity sensor and extends in an arrangement direction in which the upstream curved path and the downstream curved path are arranged, and
a distance on the arrangement line between the downstream outer curved surface and the physical quantity sensor is larger than a distance on the arrangement line between the upstream outer curved surface and the physical quantity sensor.

2. The physical quantity measurement device according to claim 1, wherein
the sensor path extends along the arrangement line.

3. The physical quantity measurement device according to claim 1, wherein
in the sensor path, a distance between the physical quantity sensor and the downstream curved path is larger than the distance between the physical quantity sensor and the upstream curved path.

4. The physical quantity measurement device according to claim 1, further comprising
a sensor support supporting the physical quantity sensor in the measurement flow path, wherein
a distance on the arrangement line between the downstream outer curved surface and the sensor support is larger than a distance on the arrangement line between the upstream outer curved surface and the sensor support.

5. The physical quantity measurement device according to claim 1, wherein
the downstream outer curved surface includes a downstream outer vertical surface provided at a position through which the arrangement line passes, the downstream outer vertical surface extending straight upstream from a downstream end part of the downstream curved path.

6. The physical quantity measurement device according to claim 1, wherein
the inner surface of the housing includes a downstream inner curved surface that defines an inner outline of the curve part of the downstream curved path, and
the downstream inner curved surface includes a downstream inner arched surface which is arched along the downstream curved path.

7. The physical quantity measurement device according to claim 1, wherein
the housing includes a measurement narrowed portion that gradually reduces and narrows the measurement flow path in a direction from the measurement inlet toward the physical quantity sensor, and gradually expands the measurement flow path in a direction from the physical quantity sensor toward the measurement outlet, and
the measurement narrowed portion is provided in the measurement flow path between an upstream end part of the upstream curved path and a downstream end part of the downstream curved path.

8. The physical quantity measurement device according to claim 7, wherein
the measurement narrowed portion includes:
a measurement narrowing surface that forms the inner surface of the housing and gradually reduces and narrows the measurement flow path in the direction from the measurement inlet toward the physical quantity sensor; and
a measurement expanding surface that gradually expands the measurement flow path in the direction from the physical quantity sensor toward the measurement outlet, and
a length of the measurement expanding surface in the arrangement direction is larger than a length of the measurement narrowing surface in the arrangement direction.

9. The physical quantity measurement device according to claim 8, wherein
the measurement expanding surface extends straight from the physical quantity sensor toward the measurement outlet.

10. The physical quantity measurement device according to claim 1, wherein
a distance on the arrangement line between the downstream outer curved surface and the measurement narrowed portion is larger than a distance on the arrangement line between the upstream outer curved surface and the measurement narrowed portion.

11. The physical quantity measurement device according to claim 1, wherein
the inner surface of the housing includes a pair of measurement wall surfaces defining the measurement flow path and facing each other across the upstream outer curved surface and the downstream outer curved surface, and
the measurement narrowed portion is provided on at least one of the pair of measurement wall surfaces.

12. The physical quantity measurement device according to claim 1, wherein
the upstream outer curved surface includes an upstream outer arched surface which is arched along the upstream curved path and connects an upstream end part of the upstream curved path and a downstream end part of the upstream curved path.

13. The physical quantity measurement device according to claim 1, wherein
the inner surface of the housing includes an inner measurement curved surface that is curved to bulge toward the physical quantity sensor and connects the measurement inlet and the measurement outlet, the inner measurement curved surface defining an inner outline of a curved part of the measurement flow path.

14. The physical quantity measurement device according to claim 1, wherein
the inner surface of the housing includes a pair of wall surfaces defining the measurement flow path and facing each other across the upstream outer curved surface and the downstream outer curved surface, and
the measurement outlet is provided on at least one of the pair of wall surfaces such that the measurement flow path is open through the measurement outlet in an orthogonal direction which is orthogonal to the arrangement line and in which the pair of wall surfaces face each other.
